(19) United States
(12) Patent Application Publication
(10) Pub. No.: US 2022/0245523 A1
(43) Pub. Date: Aug. 4, 2022

(54) MACHINE LEARNING METHOD, RECORDING MEDIUM, AND MACHINE LEARNING DEVICE

(71) Applicant: FUJITSU LIMITED, Kawasaki-shi (JP)

(72) Inventor: Takahisa YAMAMOTO, Fuchu (JP)

(73) Assignee: FUJITSU LIMITED, Kawasaki-shi (JP)

(21) Appl. No.: 17/725,592

(22) Filed: Apr. 21, 2022

Related U.S. Application Data
(63) Continuation of application No. PCT/JP2019/042225, filed on Oct. 28, 2019.

(51) Int. Cl. G06N 20/00; G06V 10/774; G06V 10/80; G06V 20/70

(52) U.S. Cl. CPC G06N 20/00; G06V 20/70; G06V 10/80; G06V 10/774

(57) ABSTRACT

A machine learning method is executed by a computer, the machine learning method including: acquiring an image; extracting, from the acquired image, a first feature vector for the entire image; extracting, from the acquired image, a second feature vector for an object; generating a third feature vector by combining together the extracted first feature vector and the extracted second feature vector; and learning a model that outputs a label indicating an impression corresponding to the feature vector input, the model being learned based on training data in which the generated third feature vector is correlated with the label indicating an impression of the image.

### CROSS-REFERENCE TO RELATED APPLICATION

This application is a continuation application of International Application PCT/JP2019/042225, filed on Oct. 28, 2019 and designating the U.S., the entire contents of which are incorporated herein by reference.

### FIELD

The embodiments discussed herein relate to machine learning technology.

### BACKGROUND

Up until now, there has been a technique of analyzing an image and estimating what kind of impression a person will have when seeing the image. This technique has sometimes been used for estimating what kind of impression a person will have when seeing an image created as an advertisement, to improve an appeal effect of the advertisement.

One example of a prior art is a technique of filtering an entire image to create a feature vector and an attention map, and using the created feature vector and attention map to estimate the impression of the image. Filtering is performed through, for example, a convolutional neural network (CNN). For example, refer to Yang, Jufeng, et al, “Weakly supervised coupled networks for visual sentiment analysis.” Proceedings of the IEEE conference on computer vision and pattern recognition. 2018.

### SUMMARY

According to an aspect of an embodiment, a machine learning method is executed by a computer, the machine learning method including: acquiring an image; extracting, from the acquired image, a first feature vector for the entire image; extracting, from the acquired image, a second feature vector for an object; generating a third feature vector by combining together the extracted first feature vector and the extracted second feature vector; and learning a model that outputs a label indicating an impression corresponding to the feature vector input, the model being learned based on training data in which the generated third feature vector is correlated with the label indicating an impression of the image.

An object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory view of one example of a machine learning method according to an embodiment.

FIG. 2 is an explanatory view of an example of an impression estimating system 200.

FIG. 3 is a block diagram depicting an example of a hardware configuration of a machine learning device.

FIG. 4 is a block diagram of a functional configuration example of a machine learning device 100.

FIG. 5 is an explanatory view of an example of an image for learning, correlated with a label “anger” indicating an impression.

FIG. 6 is an explanatory view of an example of an image for learning, correlated with a label “disgust” indicating an impression.

FIG. 7 is an explanatory view of an example of an image for learning, correlated with a label “fear” indicating an impression.

FIG. 8 is an explanatory view of an example of an image for learning, correlated with a label “joy” indicating an impression.

FIG. 9 is an explanatory view of an example of an image for learning, correlated with a label “sadness” indicating an impression.

FIG. 10 is an explanatory view of an example of an image for learning, correlated with a label “surprise” indicating an impression.

FIG. 11 is an explanatory view of an example of the model learning.

FIG. 12 is an explanatory view of an example of the model learning.

FIG. 13 is an explanatory view of an example of the model learning.

FIG. 14 is an explanatory view of an example of the model learning.

FIG. 15 is an explanatory view of an example of the model learning.

FIG. 16 is an explanatory view of an example of the model learning.

FIG. 17 is an explanatory view of an example of the model learning.

FIG. 18 is an explanatory view of an example of the model learning.

FIG. 19 is an explanatory view of an example of estimating an impression of a subject image.

FIG. 20A is an explanatory view of a display example of a label indicating an impression of a subject image.

FIG. 20B is an explanatory view of a display example of a label indicating an impression of a subject image.

FIG. 21 is a flowchart of an example of a learning procedure.

FIG. 22 is a flowchart of an example of an estimating procedure.

### DESCRIPTION OF THE INVENTION

First, problems associated with the conventional techniques are discussed. In the conventional techniques, it is difficult to estimate the impression of an image with high accuracy. For example, when a person sees an image, besides having an impression from the entire image, the person may have an impression from a part of the image and therefore, accurate estimation of what kind of impression a person will have when seeing an image is difficult by merely referring to the feature vector for the entire image.

Embodiments of a machine learning method, a recording medium, and a machine learning device are described in detail with reference to the accompanying drawings.

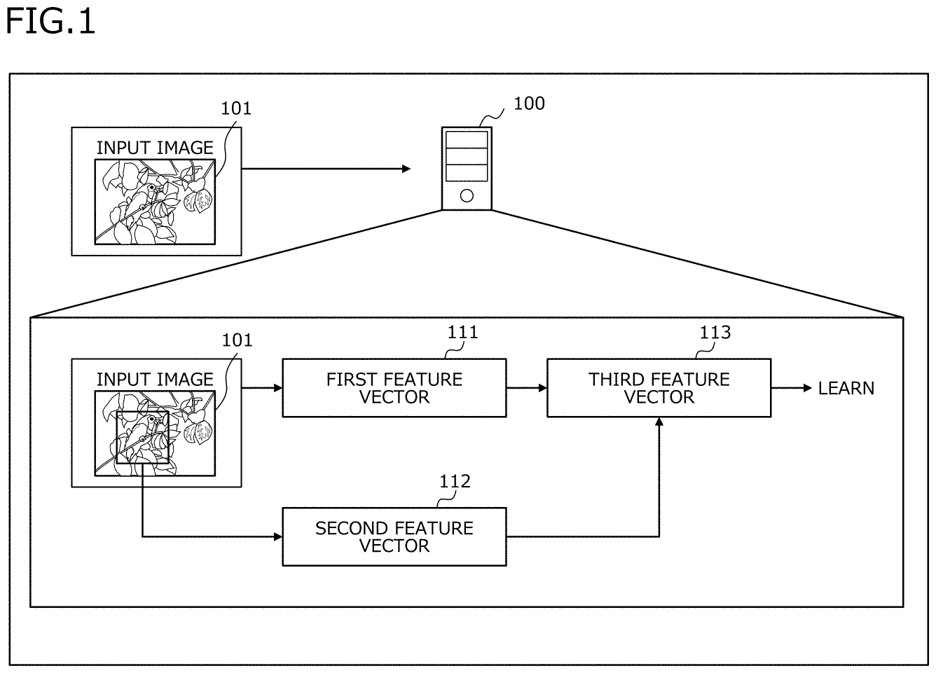

FIG. 1 is an explanatory view of one example of the machine learning method according to the embodiment. A machine learning device 100 is a computer configured to generate training data used when learning a model for estimating the impression of an image and, based on the training data, to learn the model for estimating the impression of an image.

For example, while the following various techniques are conceivable as techniques to estimate the impression of an image, accurate estimation of the image impression may be difficult with the following various techniques.

For example, a first technique that uses an action unit (AU) to estimate the impression an individual has when seeing an image of a person's face is conceivable. The first technique cannot estimate the impression an individual has when seeing an image that does not show a person's face, such as a natural scenery image or a landscape image. For this reason, the first technique cannot estimate the impression of an image created as an advertisement and hence may not be applicable to the field of advertising. The first technique has a low robustness regarding how a person's face appears in the image. For example, when the person's face in the image is a sideview, it becomes difficult to accurately estimate the impression of an image, as compared to an instance of a front view.

For example, with reference to Yang, Jufeng, et al above, a second technique that filters an entire image and creates a feature vector and an attention map, to estimate the impression of an image using the created feature vector and attention map is conceivable. Filtering is performed through, for example, the CNN. In the second technique, it is conceivable to learn a CNN coefficient using an ImageNet data set and then correct the learned CNN coefficient using a data set related to impression estimation. Also in the second technique, the smaller is the number of data sets for impression estimation, the more difficult it is to set the CNN coefficient properly, rendering it difficult to estimate the impression of an image with high accuracy. Because an impression is obtained from a part of an image in addition to an impression from the entire image, it is difficult for the second technique to accurately estimate what kind of impression a person will have when seeing an image, due to a lack of consideration of the impression obtained from a part of the image.

A multimodal third technique is conceivable that, for example, estimates the impression of an image using various sensor data in addition to the image. For example, in the third technique, it is conceivable that besides the image, the impression of an image is estimated using, for example, a sound when the image was taken or a phrase such as a caption imparted to the image. The third technique cannot be implemented unless it is possible to acquire various sensor data in addition to the image.

A fourth technique is conceivable that, for example, estimates the impression of an image using time series data related to the image. Similarly to the third technique, the fourth technique cannot be implemented unless it is possible to acquire time series data.

Thus, a technique that is applicable to various fields and situations and capable of estimating the impression of an image with high accuracy is desired. In the present embodiment, a machine learning method is described by which a model applicable to various fields and situations and capable of estimating the impression of an image with high accuracy may learned by using a feature vector for an image and a feature vector for an object.

(1-1) In FIG. 1, the machine learning device 100 acquires an image 101. The machine learning device 100 acquires, for example, an image 101 correlated with a label indicating an impression of the image 101. The label indicating an impression is, for example, anger, disgust, fear, joy, sadness, surprise, etc.

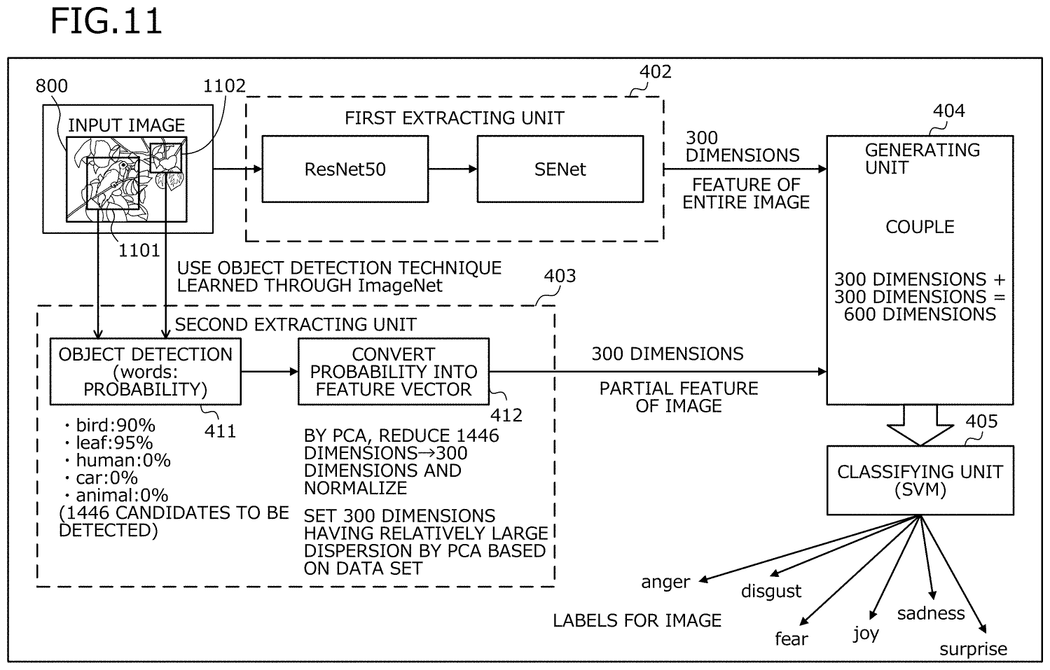

(1-2) The machine learning device 100 extracts, from the acquired image 101, a first feature vector 111 for the entire image 101. The first feature vector 111 is extracted by a CNN. A specific example of extracting the first feature vector 111 is described later with reference to FIGS. 11 to 18, for example.

(1-3) The machine learning device 100 extracts a second feature vector 112 for an object from the acquired image 101. For example, the machine learning device 100 detects a portion of the acquired image 101 where an object appears, and extracts the second feature vector 112 for the object from the detected portion. A specific example of extracting the second feature vector 112 is described later with reference to FIGS. 11 to 18, for example.

(1-4) The machine learning device 100 combines the extracted first feature vector 111 and the extracted second feature vector 112 together to generate a third feature vector 113. For example, the machine learning device 100 couples the second feature vector 112 with first feature vector 111 to generate the third feature vector 113. As for the order in which the first feature vector 111 and the second feature vector 112 are coupled together, either of the first feature vector 111 or the second feature vector 112 may come first. A specific example of generating the third feature vector 113 is described later with reference to FIGS. 11 to 18, for example.

(1-5) The machine learning device 100 learns a model, based on training data in which the generated third feature vector 113 is correlated with a label indicating an impression of the image 101. The model outputs a label that indicates an impression and that corresponds to the input feature vector. For example, the machine learning device 100 correlates the generated third feature vector 113a with a label that indicates an impression of the image 101 correlated with the acquired image 101 and, thereby, generates training data and based on the generated training data, learns a model. A specific example of learning a model is described later with reference to FIGS. 11 to 18, for example.

Thus, the machine learning device 100 may learn a model capable of accurately estimating the impression of an image. The machine learning device 100 may easily secure robustness for an image that does not show a person's face, such as a natural scenery image or a landscape image, for example and thus, may learn a model capable of estimating the impression of an image with high accuracy even in an instance of an image that does not show a person's face, such as a natural scenery image or a landscape image. For example, the machine learning device 100 may learn a model so as to be able to consider the impression of a part of an image in addition to the impression of the entire image. With the learned model, the machine learning device 100 may improve the image impression estimation accuracy and easily bring the image impression estimation accuracy to a practical accuracy level.

Thereafter, the machine learning device 100 may acquire an image to be a subject for estimating the impression. In the following description, an image to be a subject for estimating the impression may sometimes be referred to as “subject image”. Then, the machine learning device 100 may estimate the impression of the acquired subject image, using the learned model.

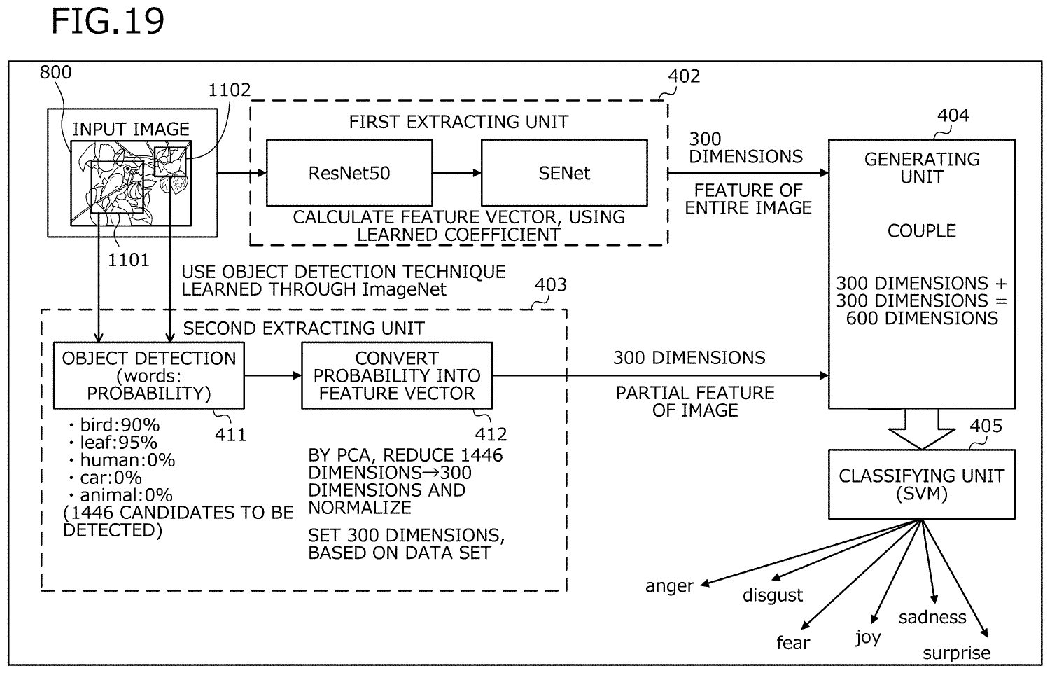

For example, the machine learning device 100 extracts a fourth feature vector for the entire subject image and a fifth feature vector for an object and combines the fourth feature vector and the fifth feature vector together, to generate a sixth feature vector. The machine learning device 100 then inputs the generated sixth feature vector into the learned model and thereby, acquires a label indicating an impression of the subject image. A specific example of acquiring a label indicating an impression of the subject image is described later with reference to FIG. 19, for example.

As a result, the machine learning device 100 may estimate the impression of the subject image with high accuracy. For example, it becomes easier for the machine learning device 100 to consider the impression of a part of the subject image in addition to the impression of the entire subject image when estimating the impression of the subject image, thereby enabling accurate estimation of the subject image. For example, the machine learning device 100 may accurately estimate the impression of a subject image that does not show a person's face, such as a natural scenery image or a landscape image. The machine learning device 100 may accurately estimate the impression of the subject image even when it is not possible to acquire various sensor data, time series data, etc. besides the subject image.

Here, for convenience of description, a case is described in which the machine learning device 100 generates one piece of training data, based on a single image 101, and learns a model based on the generated one piece of training data, but this is not limitative. For example, there may be a case in which the machine learning device 100 generates plural pieces of training data, based on plural images 101, and learns a model based on the generated plural pieces of training data. Here, the machine learning device 100 may learn a model capable of accurately estimating the impression of the image 101 with less training data.

Herein, while a case is described in which the machine learning device 100 learns a model based on training data, this is not limitative. For example, there may be a case in which the machine learning device 100 transmits training data to another computer. In this case, the other computer receiving the training data learns a model based on the received training data.

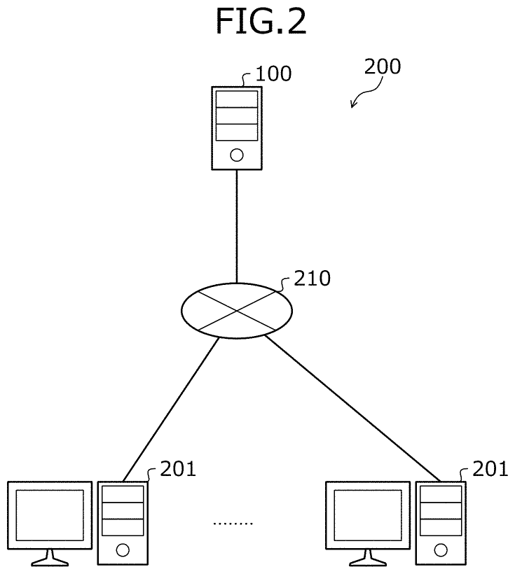

With reference to FIG. 2, an example of an impression estimating system 200 to which the machine learning device 100 in FIG. 1 is applied is described.

FIG. 2 is an explanatory view of an example of the impression estimating system 200. In FIG. 2, the impression estimating system 200 includes the machine learning device 100 and one or more client devices 201.

In the impression estimating system 200, the machine learning device 100 and the client device 201 are connected to each other via a wired or wireless network 210. The network 210 is, for example, a local area network (LAN), a wide area network (WAN), Internet, etc.

The machine learning device 100 acquires an image that is for learning a model. In the following description, an image that is for learning a model may sometimes be referred to as “image for learning”. For example, the machine learning device 100 acquires one or more images for learning by reading them from a removable record medium. For example, the machine learning device 100 may acquire one or more images for learning by receiving them via the network. For example, the machine learning device 100 may acquire one or more images for learning by receiving them from the client device 201. For example, the machine learning device 100 may acquire one or more images for learning, based on an operational input by the user of the machine learning device 100.

The machine learning device 100 generates training data, based on the acquired images for learning, and learns a model based on the generated training data. Thereafter, the machine learning device 100 acquires a subject image. The subject image may be a single image included in a moving image. For example, the machine learning device 100 acquires the subject image by receiving it from the client device 201. For example, the machine learning device 100 may acquire the subject image, based on an operational input by the user of the machine learning device 100. Using the learned model, the machine learning device 100 acquires and outputs a label indicating an impression of the acquired subject image. The output destination is, for example, the client device 201. The output destination may be, for example, a display of the machine learning device 100. The machine learning device 100 is, for example, a server, a personal computer (PC), etc.

The client device 201 is a computer communicable with the machine learning device 100. The client device 201 acquires a subject image. For example, the client device 201 acquires the subject image, based on an operational input by the user of the client device 201. The client device 201 transmits the acquired subject image to the machine learning device 100. In response to the transmission of the acquired subject image to the machine learning device 100, the client device 201 receives a label indicating an impression of the acquired subject image from the machine learning device 100. The client device 201 outputs the received label indicating an impression of the subject image. The output destination is, for example, a display of the client device 201. The client device 201 is, for example, a PC, a tablet terminal, or a smartphone.

Here, while a case is described in which the machine learning device 100 is a device different from the client device 201, this is not limitative. For example, there may be a case in which the machine learning device 100 may act also as the client device 201. In this case, the impression estimating system 200 may not include the client device 201.

Although a case is described in which the machine learning device 100 generates training data, learns a model, and acquires a label indicating an impression of a subject image, this is not limitative. For example, there may be a case in which plural devices cooperate to share the process of generating training data, the process of learning a model, and the process of acquiring a label indicating an impression of a subject image.

For example, there may be a case in which the machine learning device 100 transmits a learned model to the client device 201, and the client device 201 acquires a subject image and uses the received model to acquire and output a label indicating an impression of the acquired subject image. The output destination is, for example, a display of the client device 201. In this case, the machine learning device 100 may not acquire the subject image and the client device 201 may not transmit the subject image to the machine learning device 100.

For example, it is conceivable to utilize the impression estimating system 200 to implement a service of estimating what kind of impression a person will have when seeing an image created as an advertisement, to thereby make it easier for an image creator to improve the appeal effect of the advertisement. In this case, the client device 201 is used by the image creator.

In this case, for example, the client device 201 acquires an image created as an advertisement, based on an operational input by the image creator, and transmits the acquired image to the machine learning device 100. Using the learned model, the machine learning device 100 acquires a label indicating an impression of the image created as an advertisement, and transmits the acquired label to the client device 201. The client device 201 displays, on a display of the client device 201, the received label indicating an impression of the image created as an advertisement, thereby enabling comprehension by the image creator. As a result, the image creator may determine whether the image created as an advertisement imparts an impression that the image creator expects, to a person who sees the advertisement, whereby the appeal effect of the advertisement may be enhanced.

For example, it is conceivable to utilize the impression estimating system 200 to implement a service of estimating what kind of impression a person will have when seeing a website, to thereby make it easier for the website creator to design the website. In this case, the client device 201 is used by the website creator.

In this case, for example, the client device 201 acquires an image of the website, based on an operational input by the website creator, and transmits the acquired image to the machine learning device 100. Using the learned model, the machine learning device 100 acquires a label indicating an impression of the image of the website and transmits the acquired label to the client device 201. The client device 201 displays, on the display of the client device 201, the received label indicating an impression of the image of the website, thereby enabling comprehension by the image creator. As a result, the website creator may determine whether the website imparts an impression that the website creator expects, to a person who sees the website, thereby enabling the website creator to consider a preferable manner to design the website.

For example, it is conceivable to utilize the impression estimating system 200 to implement a service of estimating what kind of impression a person will have when seeing an image of an office space, to thereby make it easier for the operator designing the office space to design the office space. In this case, the client device 201 is used by the operator designing the office space.

In this case, for example, based on an operational input by the operator, the client device 201 acquires an image of the designed office space and transmits the acquired image to the machine learning device 100. The machine learning device 100 uses the learned model to acquire a label indicating an impression of the image of the designed office space and transmits the acquired label to the client device 201. The client device 201 displays, on the display of the client device 201, the received label indicating an impression of the image of the designed office space, thereby enabling comprehension by the operator. As a result, the operator may determine whether the office space imparts an impression that the operator expects, to a visitor to the office space, thereby enabling the operator to consider a preferable manner to design the office space.

For example, it is conceivable to utilize the impression estimating system 200 to implement a service in which images registered in a database by an image seller are automatically correlated with labels indicating impressions of the images, whereby an image buyer may search for an image having a specific impression. In this case, some of the client devices 201 are used by the image seller. Some of the client devices 201 are used by the image buyer.

In this case, for example, the client device 201 used by the image seller acquires an image to be sold, based on an operational input by the image seller, and transmits the acquired image to the machine learning device 100. On the other hand, the machine learning device 100 acquires a label indicating an impression of the acquired image by using a learned model. The machine learning device 100 correlates the acquired image with the label indicating an impression of the acquired image and registers them in the database of the machine learning device 100.

The client device 201 used by the image buyer acquires, based on an operational input of the image buyer, a label indicating an impression of an image as a condition for the search and transmits the acquired label to the machine learning device 100. The machine learning device 100 searches the database, for an image correlated with the received label indicating an impression of an image and transmits the found image to the client device 201 used by the image buyer. The client device 201 used by the image buyer displays the received image on the display of the client device 201 used by the image buyer, thereby enabling comprehension by the image buyer. This allows the image buyer to refer to an image that gives a desired impression so that the image buyer may use it for a book cover, a case decoration, a material, or the like.

Although here a case is described in which images are sold for a fee, this is not limitative. For example, there may be a case in which images are distributed free of charge. The image seller may be able to register keywords besides the labels indicating impressions of images, while the image buyer may be able to search for an image using keywords in addition to the labels indicating impressions of images.

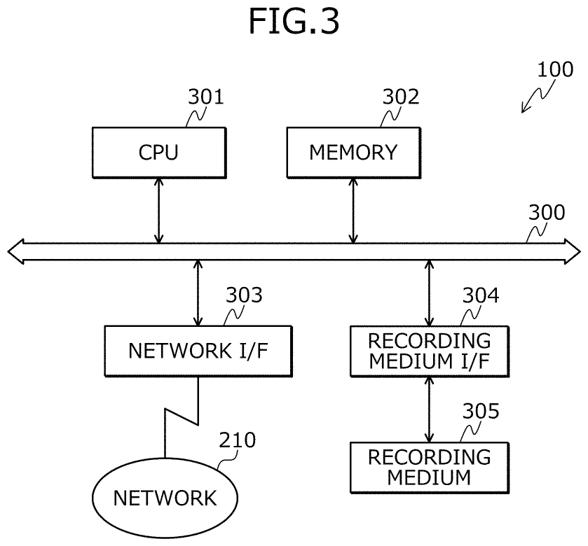

Next, an example of hardware configuration of the machine learning device is described with reference to FIG. 3.

FIG. 3 is a block diagram depicting an example of hardware configuration of the machine learning device. In FIG. 3, the machine learning device has a central processing unit (CPU) 301, memory 302, network interface (I/F) 303, a recording medium I/F 304, and a recording medium 305. These components are connected to one another by a bus 300.

Here, the CPU 301 governs overall control of the machine learning device. The memory 302, for example, includes a read only memory (ROM), a random access memory (RAM), and a flash ROM, etc. In particular, for example, the flash ROM and the ROM store various types of programs and the RAM us use as a work area of the CPU 301. The programs stored to the memory 302 are loaded onto the CPU 301, whereby encoded processes are executed by the CPU 301.

The network I/F 303 is connected to a network 210 through a communications line and is connected to other computers via the network 210. Further, the network I/F 303 administers an internal interface with the network 210 and controls the input and output of data from the other computers. The network I/F 303, for example, is a modem, a LAN adapter, or the like.

The recording medium I/F 304 controls the reading and writing of data to the recording medium 305 under the control of the CPU 301. The recording medium I/F 304, for example, is a disk drive, a solid-state drive (SSD), a universal serial bus (USB) port, or the like. The recording medium 305 is non-volatile memory storing therein data written thereto under the control of the recording medium I/F 304. The recording medium 305, for example, is a disk, semiconductor memory, a USB memory, or the like. The recording medium 305 may be removable from the machine learning device.

The machine learning device may have, for example, a keyboard, a mouse, a display, a printer, a scanner, a microphone, a speaker, etc. in addition to the above components. Further, the machine learning device may have the recording medium I/F 304 and/or the recording medium 305 in plural. Further, the machine learning device may omit the recording medium I/F 304 and/or the recording medium 305.

An example of a hardware configuration of the client device 201 is the same as the example of the hardware configuration of the machine learning device depicted in FIG. 3 and therefore, description thereof is omitted hereinafter.

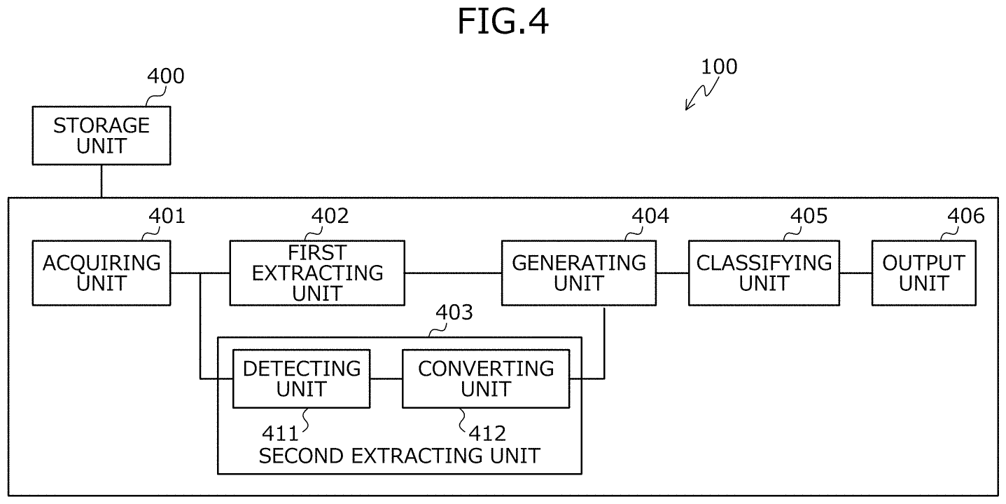

Next, a functional configuration example of the machine learning device 100 is described with reference to FIG. 4.

FIG. 4 is a block diagram of the functional configuration example of the machine learning device 100. The machine learning device 100 includes a storage unit 400, an acquiring unit 401, a first extracting unit 402, a second extracting unit 403, a generating unit 404, a classifying unit 405, and an output unit 406. The second extracting unit 403 includes, for example, a detecting unit 411 and a converting unit 412.

The storage unit 400 is implemented by, for example, a storage area such as the memory 302 and the record medium 305 depicted in FIG. 3. In the following, while a case is described in which the storage unit 400 is included in the machine learning device 100, configuration is not limited hereto. For example, there may be a case in which the storage unit 400 is included in a device different from the machine learning device 100 so that the storage contents of the storage unit 400 can be referred to from the machine learning device 100.

The acquiring unit 401 to the output unit 406 function as one example of a controller. The acquiring unit 401 to the output unit 406 implement their respective functions, for example, by a program stored in the storage area such as the memory 302 and the record medium 305 depicted in FIG. 3 being executed by the CPU 301, or by the network I/F 303. Results of processing of each functional unit is stored to, for example, the storage area such as the memory 302 and the record medium 305 depicted in FIG. 3.

The storage unit 400 is referred to in the processing of each functional unit or stores various updated pieces of information. The storage unit 400 stores a model that outputs a label indicating an impression of an image that corresponds to the input feature vector. The model is, for example, a support vector machine (SVM). The model may be, for example, a tree-structured network. The model may be, for example, a mathematical formula. The model may be, for example, a neural network. For example, the model is referred to or updated by the classifying unit 405. The label indicating an impression is, for example, anger, disgust, fear, joy, sadness, surprise, etc. The vector corresponds to, for example, an array of elements.

The storage unit 400 stores an image. The image is, for example, a photograph or a painting. The image may be a single image included in a moving image. The storage unit 400 stores, in correlation with each other, an image for learning and a label indicating an impression of the image for learning. The image for learning is for learning a model. For example, the image for learning is acquired by the acquiring unit 401 and is referred to by the first extracting unit 402 and the second extracting unit 403. For example, a label indicating an impression of an image for learning is acquired by the acquiring unit 401 and is referred to by the classifying unit 405. The storage unit 400 stores, for example, a subject image. A subject image is a subject whose impression is to be estimated. For example, a subject image is acquired by the acquiring unit 401 and is referred to by the first extracting unit 402 and the second extracting unit 403.

The acquiring unit 401 acquires various pieces of information used for the processes of the functional units. The acquiring unit 401 stores the acquired various pieces of information to the storage unit 400 or outputs the information to the functional units. The acquiring unit 401 may output various pieces of information stored in the storage unit 400 to the functional units. The acquiring unit 401 acquires various pieces of information, based on, for example, an operational input by the user of the machine learning device 100. The acquiring unit 401 may acquire various pieces of information, for example, from a device different from the machine learning device 100.

The acquiring unit 401 acquires an image. The acquiring unit 401 acquires, for example, an image for learning correlated with a label indicating an impression of the image for learning. For example, the acquiring unit 401 acquires an image for learning correlated with a label indicating an impression of the image for learning, based on an operational input by the user of the machine learning device 100. For example, the acquiring unit 401 may acquire an image for learning correlated with a label indicating an impression of the image for learning, by reading the image from the removable record medium 305. For example, the acquiring unit 401 may acquire an image for learning correlated with a label indicating an impression of the image for learning, by receiving the image from another computer. The other computer is, for example, the client device 201.

The acquiring unit 401 acquires, for example, a subject image. For example, the acquiring unit 401 acquires a subject image by receiving the subject image from the client device 201. For example, the acquiring unit 401 may acquire a subject image, based on an operational input by the user of the machine learning device 100. For example, the acquiring unit 401 may acquire a subject image, by reading the subject image from the removable record medium 305.

The acquiring unit 401 may receive a starting trigger to start a process of any functional unit. The starting trigger is, for example, a predetermined operational input by the user of the machine learning device 100. The starting trigger may be, for example, reception of predetermined information from another computer. The starting trigger may be, for example, output of predetermined information by any functional unit.

The acquiring unit 401 takes, for example, acquisition of an image for learning, as the starting trigger for the processes of the first extracting unit 402 and the second extracting unit 403. The acquiring unit 401 takes, for example, acquisition of a subject image, as the starting trigger for the processes of the first extracting unit 402 and the second extracting unit 403.

The first extracting unit 402 extracts a feature vector for an entire image from the acquired image. The first extracting unit 402 extracts, for example, a first feature vector for an entire image for learning from the acquired image for learning. For example, the first extracting unit 402 applies CNN filtering to the acquired image for learning and thereby, extracts the first feature vector. The CNN filtering technique is, for example, a residual network (ResNet) or a squeeze-and-excitation network (SENet). As a result, the first extracting unit 402 enables the generating unit 404 to refer to the feature vector for an entire image and to, thereby, generate a feature vector that serves as a reference for image classification.

The second extracting unit 403 extracts a feature vector for an object from the acquired image. The object is set, for example, in advance as a candidate to be detected from an image. The second extracting unit 403 extracts, for example, a second feature vector for an object from the acquired image for learning. For example, the second extracting unit 403 extracts the second feature vector from the image for learning by using the detecting unit 411 and the converting unit 412. As a result, the second extracting unit 403 enables the generating unit 404 to refer to the feature vector for an object and to, thereby, generate a feature vector that serves as a reference for image classification.

The detecting unit 411 analyzes an image and detects each of one or more objects from the image. The detecting unit 411 analyzes, for example, an image for learning and, based on the result of analysis of the image for learning, calculates a probability at which each of the one or more objects appears in the image for learning. The probability corresponds to reliability of the object detection. As a result, the detecting unit 411 may obtain information for generating the second feature vector.

The detecting unit 411 analyzes, for example, an image for learning and, based on the result of analysis of the image for learning, determines whether each of the one or more objects appears in the image for learning. For example, based on the result of analysis of the image for learning, the detecting unit 411 calculates a probability at which each of the one or more objects appears in the image for learning and determines an object having a probability at least equal to a threshold value as appearing in the image for learning. As a result, the detecting unit 411 may obtain information for generating the second feature vector.

For example, the detecting unit 411 analyzes an image for learning and, based on the result of analysis of the image for learning, specifies for each of one or more objects, the size thereof in the image for learning. For example, the detecting unit 411 uses a technique such as a single shot multibox detector (SSD) or a you look only once (YOLO), to specify the size of a bounding box of each of the one or more objects. As a result, the detecting unit 411 may obtain information for generating the second feature vector.

For example, the detecting unit 411 analyzes an image for learning and, based on the result of analysis of the image for learning, specifies for each of the one or more objects, a color feature thereof in the image for learning. The color feature is, for example, in a color histogram. The color is expressed by, for example, a red-green-blue (RGB) format, a hue-saturation-lightness (HSL) format, or a hue-saturation-brightness (HSB) format. As a result, the detecting unit 411 may obtain information for generating the second feature vector.

The converting unit 412 generates a second feature vector. The converting unit 412 generates the second feature vector, based on, for example, the calculated probability. For example, the converting unit 412 generates the second feature vector in which a probability calculated for each object is arranged as an element. As a result, the converting unit 412 may generate a third feature vector.

The converting unit 412 generates the second feature vector, based on, for example, the specified size. For example, the converting unit 412 generates the second feature vector in which the size specified for each object is arranged as an element. As a result, the converting unit 412 may generate the third feature vector.

The converting unit 412 generates the second feature vector, based on, for example, the specified color feature. The color feature is, for example, in a color histogram. For example, the converting unit 412 generates the second feature vector in which the color feature specified for each object is arranged as an element. As a result, the converting unit 412 may generate the third feature vector.

The converting unit 412 may generate the second feature vector, based on, for example, a combination of at least two among: the calculated probability, the specified size, and the specified color feature. For example, the converting unit 412 generates the second feature vector in which the probability calculated for each object is weighted by the size specified for each object and is arranged as an element. As a result, the converting unit 412 may generate the third feature vector.

The converting unit 412 generates the second feature vector, based on, for example, the name of an object among one or more objects, determined as appearing in an image for learning. For example, the converting unit 412 generates the second feature vector in which the name of an object determined as appearing in an image for learning is vector-converted and arranged using a technique such as word2vec or global vectors for word representation (GloVe). As a result, the converting unit 412 may generate the third feature vector.

The converting unit 412 generates the second feature vector, based on, for example, the size in an image for learning, of an object that is among one or more objects and determined as appearing in the image for learning. For example, the converting unit 412 generates the second feature vector in which the name of an object determined as appearing in an image for learning is vector-converted, weighted by the size specified for the object, and arranged as an element. As a result, the converting unit 412 may generate the third feature vector.

The converting unit 412 generates the second feature vector, based on, for example, the name of an object having at least a certain size on an image for learning, determined as appearing in the image for learning. For example, the converting unit 412 generates the second feature vector in which the name of an object having at least a certain size in an image for learning and determined as appearing in the image for learning is vector-converted and arranged. As a result, the converting unit 412 may generate the third feature vector.

The converting unit 412 generates the second feature vector, based on, for example, the color feature in an image for learning of an object that is among one or more objects and determined as appearing in the image for learning. For example, the converting unit 412 generates the second feature vector in which the name of an object determined as appearing in an image for learning is vector-converted, weighted based on the color feature specified for the object, and arranged as an element. As a result, the converting unit 412 may generate the third feature vector.

The generating unit 404 combines the generated first feature vector and the generated second feature vector together to generate the third feature vector. For example, the generating unit 404 couples a second feature vector of M dimensions to a first feature vector of N dimensions to thereby generate a third feature vector of N+M dimensions. Here, N=M may be true. As a result, the generating unit 404 may obtain an input sample to a model.

For example, the generating unit 404 generates, as a third feature vector, the sum of elements or the product of elements of a first feature vector and a second feature vector. As a result, the generating unit 404 may obtain an input sample to a model.

For example, the generating unit 404 couples together the sum of elements and the product of elements of the first feature vector and the second feature vector together to thereby generate the third feature vector. As a result, the generating unit 404 may obtain an input sample to a model.

The classifying unit 405 learns a model. For example, the classifying unit 405 generates training data in which the generated third feature vector is correlated with a label indicating an impression of an image for learning, and learns a model based on the generated training data. For example, the classifying unit 405 generates training data in which the generated third feature vector is correlated with a label indicating an impression of an image for learning. The classifying unit 405 then updates the model by a margin maximizing technique, based on the training data. As a result, the machine learning device 100 may learn a model capable of estimating the impression of an image with high accuracy.

For example, the classifying unit 405 generates training data in which the generated third feature vector is correlated with a label indicating an impression of an image for learning. The classifying unit 405 then uses a model to specify a label that indicates the impression corresponding to the third feature vector contained in the training data, and compares the specified label and the label contained in the training data to update the model. As a result, the machine learning device 100 may learn the model capable of estimating the impression of an image with high accuracy.

Here, an example of actions when the acquiring unit 401 acquires an image for learning has been described as an example of actions of the first extracting unit 402, the second extracting unit 403, the generating unit 404, and the classifying unit 405. An example of actions when the acquiring unit 401 acquires a subject image is described as an example of actions of the first extracting unit 402, the second extracting unit 403, the generating unit 404, and the classifying unit 405.

The first extracting unit 402 extracts, from the acquired subject image, a fourth feature vector for the entire subject image. The first extracting unit 402 extracts a fourth feature vector from the acquired subject image, similarly to the first feature vector. As a result, the first extracting unit 402 enables the generating unit 404 to refer to the feature vector for the entire image to generate a feature vector that serves as a reference for classification of the subject image.

The second extracting unit 403 extracts a fifth feature vector for an object, from the acquired subject image. The second extracting unit 403 extracts a fifth feature vector from the acquired subject image, similarly to the second feature vector. As a result, the second extracting unit 403 enables the generating unit 404 to refer to the feature vector for an object to generate a feature vector that serves as a reference for classification of the subject image.

The generating unit 404 combines the extracted fourth feature vector and the extracted fifth feature vector together and thereby, generates the sixth feature vector. The generating unit 404 generates the sixth feature vector, for example, similarly to the third feature vector. Thus, the generating unit 404 may obtain the sixth feature vector that serves as a reference for classification of the subject image.

Using a model, the classifying unit 405 specifies a label that is a classification destination for classifying the acquired subject image. For example, using a model, the classifying unit 405 specifies, as the label that is a classification destination for classifying the subject image, a label indicating an impression corresponding to the generated sixth feature vector. Thus, the classifying unit 405 may classify the subject image with high accuracy.

The output unit 406 outputs results of processing of the functional units. The form of output is, for example, display onto a display, print output to a printer, transmission to an external device via the network I/F 303, or storage to a storage area such as the memory 302 or the record medium 305. Thus, the output unit 406 may notify the user of the machine learning device 100 or the user of the client device 201 of the result of processing of the functional units, thereby improving the convenience of the machine learning device 100.

The output unit 406 outputs, for example, a learned model. For example, the output unit 406 transmits the learned model to another computer. As a result, the output unit 406 may render the learned model available by another computer. As a result, another computer may classify a subject image with high accuracy using the model.

The output unit 406 outputs, for example, a label that is a classification destination for classifying the specified subject image. For example, the output unit 406 displays on the display, the label that is a classification destination for classifying the specified subject image. As a result, the output unit 406 may make available the label that is a classification destination for classifying the subject image. Hence, the user of the machine learning device 100 may refer to a label that is a classification destination for classifying the subject image.

Although here a case has been described in which the first extracting unit 402, the second extracting unit 403, the generating unit 404, and the classifying unit 405 perform predetermined processes for the image for learning and the subject image, this is not limitative. For example, there may be a case in which the first extracting unit 402, the second extracting unit 403, the generating unit 404, and the classifying unit 405 do not perform predetermined processes for the subject image. In such cases, another computer may perform the predetermined processing for the subject image.

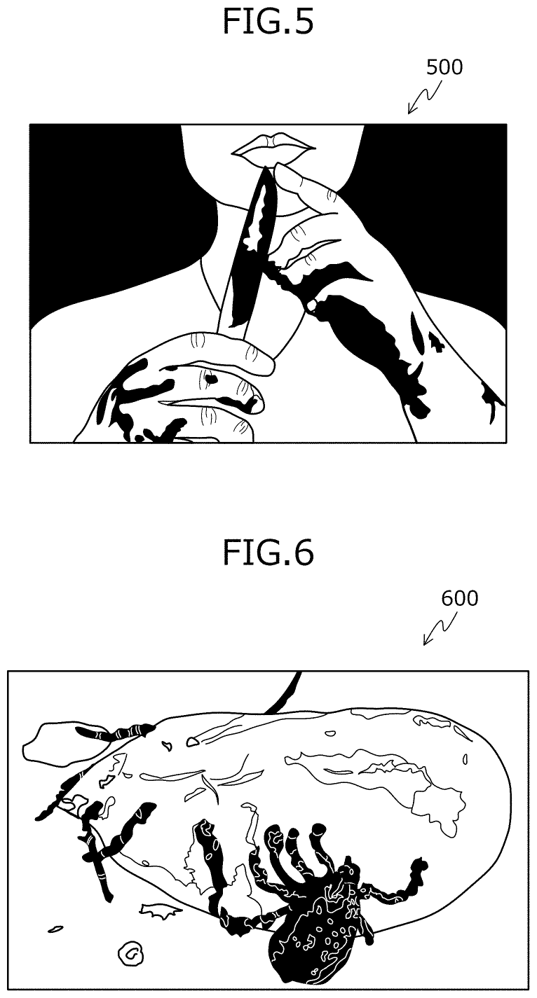

Next, with reference to FIGS. 5 to 19, an action example of the machine learning device 100 is described. For example, first, with reference to FIGS. 5 to 10, an example is described of the image for learning used when the machine learning device 100 learns a model.

FIG. 5 is an explanatory view of an example of the image for learning, correlated with a label “anger” indicating an impression. The label “anger” indicating an impression shows that the impression a person will have when seeing an image tends to be that of anger. In the following description, an image for learning correlated with the label “anger” indicating an impression may be referred to as “anger image”.

In FIG. 5, an image 500 is an example of an anger image and is, for example, an image of a person holding a blade with blood. In addition, for example, an image that shows a scene such as quarrel, fight, war, or riot is conceivable as an anger image. Furthermore, for example, an image that personifies the wrath of natural forces such as lightning, tornado, and flood is conceivable as an anger image. Description proceeds to FIG. 6.

FIG. 6 is an explanatory view of an example of an image for learning, correlated with a label “disgust” indicating an impression. The label “disgust” indicating an impression shows that the impression a person will have when seeing an image tends to be that of disgust. In the following description, an image for learning correlated with the label “disgust” indicating an impression may be referred to as “disgust image”.

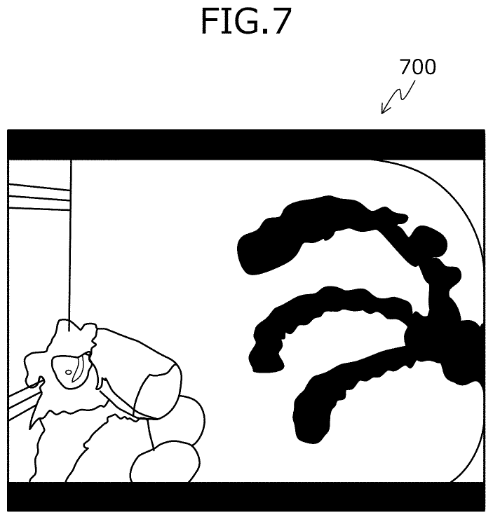

In FIG. 6, an image 600 is an example of a disgust image and is, for example, an image of a worm-eaten fruit. In addition, for example, an image that shows a worm, a corpse, etc. is conceivable as a disgust image. Furthermore, for example, an image that shows a dirty person, thing, place, etc. is conceivable as a disgust image. Description proceeds to FIG. 7.

FIG. 7 is an explanatory view of an example of an image for learning, correlated with a label “fear” indicating an impression. The label “fear” indicating an impression shows that the impression a person will have when seeing an image tends to be that of fear. In the following description, an image for learning correlated with the label “fear” indicating an impression may be referred to as “fear image”.

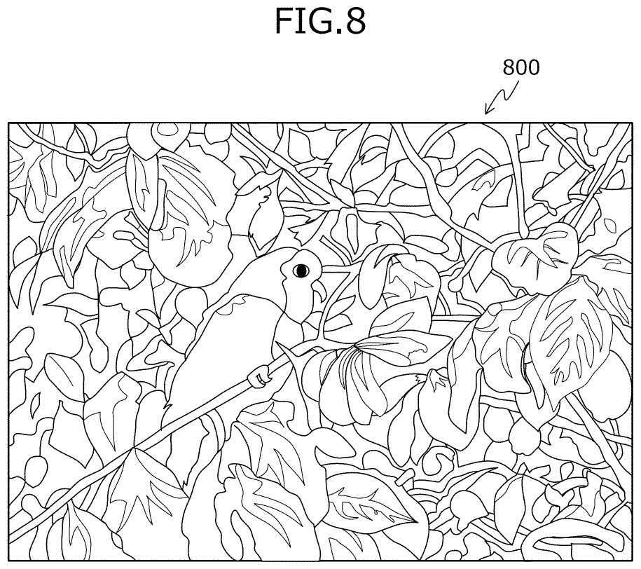

In FIG. 7, an image 700 is an example of a fear image and is an image of a silhouette of a monster's hand. In addition, for example, an image that shows a downward direction from a high place such as a roof of a building is conceivable as a fear image. Furthermore, for example, an image that shows, for example, an insect, a monster, or a skeleton is conceivable as a fear image. Description proceeds to FIG. 8.

FIG. 8 is an explanatory view of an example of an image for learning, correlated with a label “joy” indicating an impression. The label “joy” indicating an impression shows that the impression a person will have when seeing an image tends to be that of joy or fun. In the following description, an image for learning correlated with the label “joy” indicating an impression may be referred to as “joy image”.

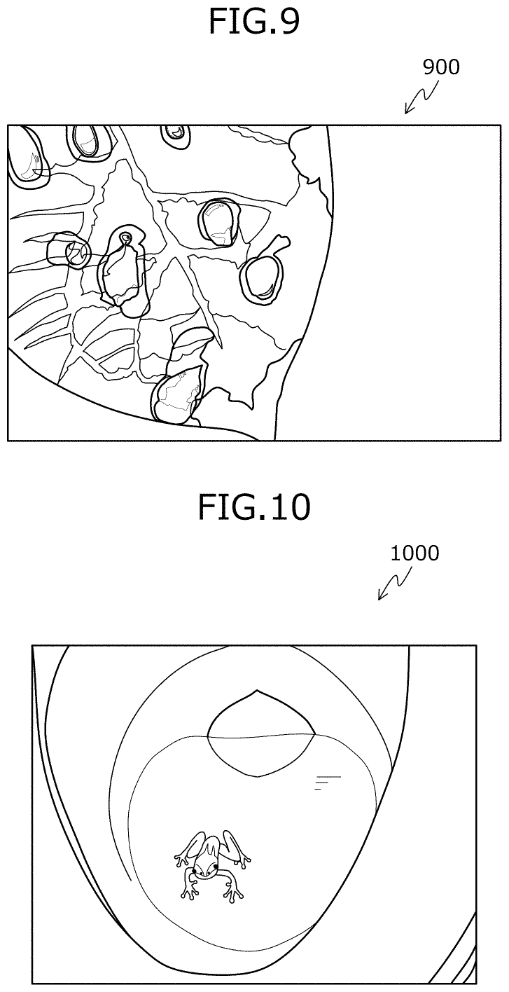

In FIG. 8, an image 800 is an example of a joy image and is an image of a bird sitting in a tree. In addition, for example, an image that shows, for example, a flower, a jewel, or a child is conceivable as a joy image. Furthermore, for example, an image of a leisure scene is conceivable as the joy image. Also, for example, an image whose color tone is a bright tone is conceivable as a joy image. Description proceeds to FIG. 9.

FIG. 9 is an explanatory view of an example of an image for learning, correlated with a label “sadness” indicating an impression. The label “sadness” indicating an impression shows that the impression a person will have when seeing an image tends to be that of sadness or sorrow. In the following description, an image for learning, correlated with the label “sadness” indicating an impression may be referred to as “sadness image”.

In FIG. 9, an image 900 is an example of a sadness image and is an image whose color tone is a dark tone, showing a leaf with water drops. In addition, as a sadness image, for example, an image of a sad person is conceivable. Furthermore, for example, an image of a statue imitating a sad person is conceivable as a sadness image. Also, for example, an image showing the traces of a disaster is conceivable as a sadness image. Description proceeds to FIG. 10.

FIG. 10 is an explanatory view of an example of an image for learning, correlated with a label “surprise” indicating an impression. The label “surprise” indicating an impression shows that the impression a person will have when seeing an image tends to be that of astonishment. In the following description, the image for learning correlated with the label “surprise” indicating an impression may be referred to as “surprise image”.

In FIG. 10, an image 1000 is an example of the surprise image and is an image of a scene where there is a frog when a cover of a toilet seat is opened. In addition, for example, is an image of nature such as a flower field or an image of an animal conceivable as a surprise image. Furthermore, for example, an image of a scene of an accident is conceivable as a surprise image. Also, for example, an image showing a present such as a ring for proposal is conceivable as a surprise image.

Next, with reference to FIGS. 11 to 18, an example is described in which the machine learning device 100 learns a model using an image for learning.

FIGS. 11, 12, 13, 14, 15, 16, 17, and 18 are explanatory views of an example of the model learning. In FIG. 11, (11-1) the machine learning device 100 acquires, as an image for learning, the image 800 correlated with the label “joy” indicating an impression. For example, the machine learning device 100 receives, from a client device, the image 800 correlated with the label “joy” indicating an impression.

(11-2) The machine learning device 100, by the first extracting unit 402, generates from the image 800, a first feature vector for the entire image 800. The first extracting unit 402 generates the first feature vector for the entire image 800 by, for example, ResNet50 with built-in SENet. The first feature vector has, for example, 300 dimensions. Thus, the machine learning device 100 may obtain the first feature vector representative of a feature of the entire image 800.

(11-3) By the detecting unit 411 included in the second extracting unit 403, the machine learning device 100 detects from the image 800, each of 1446 objects to be candidates for detection and outputs the result of detection to the converting unit 412. The objects to be candidates for detection are, for example, a bird, a leaf, a human, a car, an animal, etc.

For example, using an object detection technique learned through ImageNet, the detecting unit 411 detects a bird from a portion 1101 of the image 800 and obtains, by calculation, a probability of 90% that the image 800 shows a bird. In the same manner, the detecting unit 411 detects a leaf from a portion 1102 of the image 800 and obtains, by calculation, a probability of 95% that the image 800 shows a leaf. At this time, the detecting unit 411 sets to 0%, the probabilities that the image 800 shows a human, a car, an animal, etc. which have not been detected. Thus, the machine learning device 100 may easily take into consideration the impression of combined objects as well.

(11-4) By the converting unit 412 included in the second extracting unit 403, the machine learning device 100 generates a second feature vector for an object, based on the result of detection.

The converting unit 412 generates, for example, a feature vector of 1446 dimensions in which the probabilities of the image 800 showing a bird, a leaf, a human, a car, an animal, etc. are arranged as elements. Using principal component analysis (PCA), the converting unit 412 then converts the generated feature vector of 1446 dimensions into a feature vector of 300 dimensions, performs normalization, and sets the normalized feature vector as the second feature vector.

In the PCA, 300 dimensions having a relatively large dispersion are set as dimensions of the conversion destination. In the PCA, 300 dimensions are set based on, for example, a predetermined data set. The predetermined data set is, for example, an existing data set. The predetermined data set may be, for example, a feature vector of 1446 dimensions obtained from each of plural images for learning. Thus, the machine learning device 100 may obtain a second feature vector representative of a partial feature of the image 800.

(11-5) The machine learning device 100 couples the first feature vector and the second feature vector together, by the generating unit 404. The generating unit 404 couples, for example, the first feature vector of 300 dimensions and the second feature vector of 300 dimensions together and thereby, generates a third feature vector of 600 dimensions.

(11-6) The machine learning device 100, by the classifying unit 405, generates training data in which the third feature vector is correlated with a correct label and updates a model based on the training data. The model is, for example, SVM. The correct label is a label “joy” indicating an impression correlated with the image 800. For example, the classifying unit 405 generates training data in which the third feature vector is correlated with the correct label, and updates SVM by the margin maximizing technique, based on the generated training data. As a result, the machine learning device 100 may update the model so as to be able to estimate the impression of an image with high accuracy.

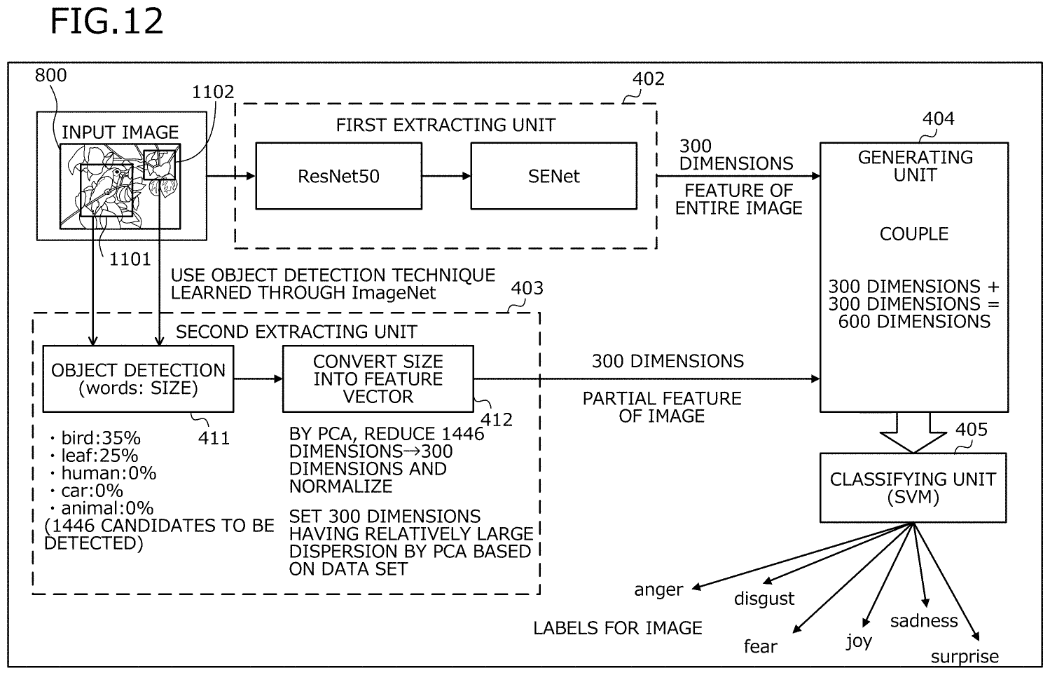

Description proceeds to FIG. 12, and a case is described in which the machine learning device 100 generates the second feature vector by a technique different from that in the description of FIG. 11.

(12-1) Similar to (11-1), in FIG. 12, the machine learning device 100 acquires, as an image for learning, the image 800 correlated with the label “joy” indicating an impression.

(12-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(12-3) By the detecting unit 411 included in the second extracting unit 403, the machine learning device 100 detects, from the image 800, each of 1446 objects to be candidates for detection, and outputs the result of detection to the converting unit 412.

For example, using the object detection technique learned through ImageNet, the detecting unit 411 detects a bird from the portion 1101 of the image 800 and specifies a size of 35% at which the image 800 shows the bird. Here, the size is specified, for example, as a rate of a portion showing an object to the entire image 800. For example, if objects that are the same are shown in the image 800, the size may be specified as a statistical value of the size at which each object is shown. The statistical value is, for example, a maximum value, an average value, a total value, etc.

The detecting unit 411 detects a leaf from the portion 1102 of the image 800 and specifies a size of 25% at which the leaf is shown in the image 800. At this time, the detecting unit 411 sets to 0%, the sizes in the image 800, of a human, a car, an animal, etc. that have not been detected. Thus, the machine learning device 100 may easily take into consideration the impression of combined objects as well.

(12-4) By the converting unit 412 included in the second extracting unit 403, the machine learning device 100 generates a second feature vector for an object based on the result of detection.

The converting unit 412 generates, for example, a feature vector of 1446 dimensions in which the sizes in the image 800, of a bird, a leaf, a human, a car, an animal, etc. are arranged as elements. Using the PCA, the converting unit 412 then converts the generated feature vector of 1446 dimensions into a feature vector of 300 dimensions, performs normalization, and sets the normalized feature vector as the second feature vector. In the PCA, 300 dimensions having a relatively large dispersion are set as dimensions of the conversion destination. Thus, the machine learning device 100 may obtain a second feature vector representative of a partial feature of the image 800.

(12-5) Similar to (11-5), the machine learning device 100 couples the first feature vector and the second feature vector together, by the generating unit 404.

(12-6) Similar to (11-6), by the classifying unit 405, the machine learning device 100 generates training data in which the third feature vector is correlated with a correct label and updates the model, based on the training data. As a result, the machine learning device 100 may update the model so as to be able to estimate the impression of an image with high accuracy.

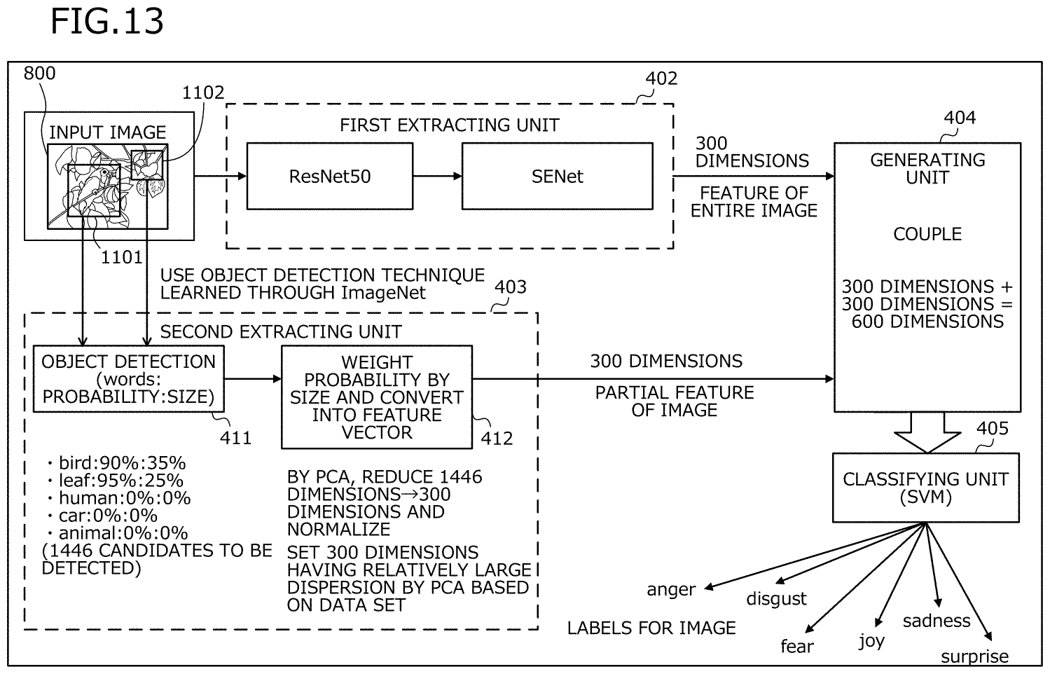

Description proceeds to FIG. 13, and a case is described in which the machine learning device 100 generates the second feature vector by a technique different from the techniques in the descriptions of FIGS. 11 and 12.

(13-1) Similar to (11-1), in FIG. 13, the machine learning device 100 acquires, as an image for learning, the image 800 correlated with the label “joy” indicating an impression.

(13-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(13-3) By the detecting unit 411 included in the second extracting unit 403, the machine learning device 100 detects, from the image 800, each of 1446 objects to be candidates for detection, and outputs the result of detection to the converting unit 412.

For example, the detecting unit 411 detects a bird from the portion 1101 of the image 800 by using the object detection technique learned through ImageNet, obtains, by calculation, a probability of 90% that the image 800 shows a bird, and specifies a size of 35% at which the image 800 shows a bird.

Similarly, the detecting unit 411 detects a leaf from the portion 1102 of the image 800, obtains, by calculation, a probability of 95% that the image 800 shows a leaf, and specifies a size of 25% at which the leaf is shown in the image 800. At this time, the detecting unit 411 sets to 0%, the probabilities and sizes at which the image 800 shows a human, a car, an animal, etc. which have not been detected. Thus, the machine learning device 100 may easily take into consideration the impression of combined objects as well.

(13-4) By the converting unit 412 included in the second extracting unit 403, the machine learning device 100 generates a second feature vector for an object based on the result of detection.

The converting unit 412 generates, for example, a feature vector of 1446 dimensions in which the probability of the image 800 showing a bird, a leaf, a human, a car, an animal, etc. are weighted by the sizes thereof in the image 800 and are arranged as elements. The converting unit 412 generates, for example, a feature vector of 1446 dimensions in which the probabilities of the image 800 showing a bird, a leaf, a human, a car, an animal, etc. are multiplied by the sizes thereof in the image 800 and are arranged as elements.

Using the PCA, the converting unit 412 then converts the generated feature vector of 1446 dimensions into a feature vector of 300 dimensions and sets the resulting feature vector as the second feature vector. In the PCA, 300 dimensions having a relatively large dispersion are set as dimensions of the conversion destination. Thus, the machine learning device 100 may obtain a second feature vector representative of a partial feature of the image 800.

(13-5) Similar to (11-5), the machine learning device 100 couples the first feature vector and the second feature vector together, by the generating unit 404.

(13-6) Similar to (11-6), by the classifying unit 405, the machine learning device 100 generates training data in which the third feature vector is correlated with a correct label and updates the model based on the training data. As a result, the machine learning device 100 may update the model so as to be able to estimate the impression of an image with high accuracy.

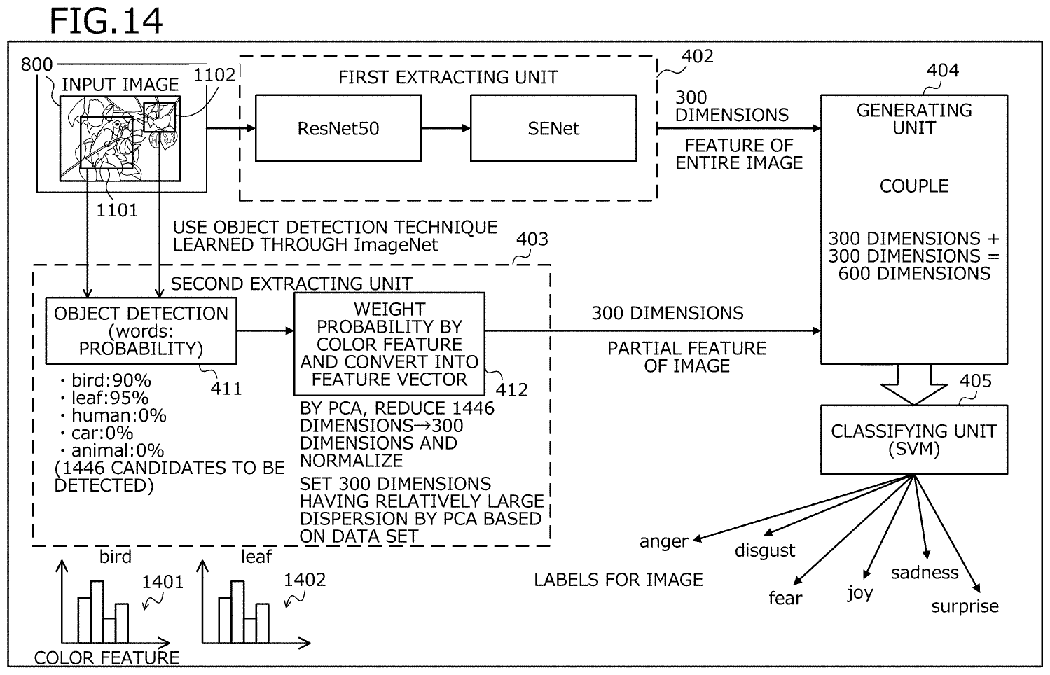

Description proceeds to FIG. 14, and a case is described in which the machine learning device 100 generates the second feature vector by a technique different from the techniques in the descriptions of FIGS. 11 and 13.

(14-1) Similar to (11-1), in FIG. 14, the machine learning device 100 acquires, as an image for learning, the image 800 correlated with the label “joy” indicating an impression.

(14-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(14-3) By the detecting unit 411 included in the second extracting unit 403, the machine learning device 100 detects, from the image 800, each of 1446 objects to be candidates for detection, and outputs the result of detection to the converting unit 412.

For example, the detecting unit 411 detects a bird from the portion 1101 of the image 800 by using the object detection technique learned through ImageNet, obtains, by calculation, a probability of 90% that the image 800 shows a bird, and specifies a color feature of the portion 1101. The color feature is represented by, for example, a color histogram. The color histogram is, for example, a bar graph representative of the number of colors. For example, the color histogram is a bar graph representative of the number of colors of each luminance.

Similarly, the detecting unit 411 detects a leaf from the portion 1102 of the image 800, obtains, by calculation, a probability of 95% that the image 800 shows a leaf, and specifies a color feature of the portion 1102. At this time, the detecting unit 411 sets to 0%, the probabilities that the image 800 shows a human, a car, an animal, etc. which have not been detected. Thus, the machine learning device 100 may easily take into consideration the impression of combined objects as well.

(14-4) By the converting unit 412 included in the second extracting unit 403, the machine learning device 100 generates a second feature vector for an object, based on the result of detection.

The converting unit 412 generates, for example, a feature vector of 1446 dimensions in which the probabilities of the image 800 showing a bird, a leaf, a human, a car, an animal, etc. are weighted by a color feature and are arranged as elements. The converting unit 412 generates, for example, a feature vector of 1446 dimensions in which the probabilities of the image 800 showing a bird, a leaf, a human, a car, an animal, etc. are multiplied by a peak luminance and are arranged as elements.

Using the PCA, the converting unit 412 then converts the generated feature vector of 1446 dimensions into a feature vector of 300 dimensions and sets the resulting feature vector as the second feature vector. In the PCA, 300 dimensions having a relatively large dispersion are set as dimensions of the conversion destination. Thus, the machine learning device 100 may obtain a second feature vector representative of a partial feature of the image 800.

(14-5) Similar to (11-5), the machine learning device 100 couples the first feature vector and the second feature vector together, by the generating unit 404.

(14-6) Similar to (11-6), by the classifying unit 405, the machine learning device 100 generates training data in which the third feature vector is correlated with a correct label and updates the model based on the training data. As a result, the machine learning device 100 may update the model so as to be able to estimate the impression of an image with high accuracy.

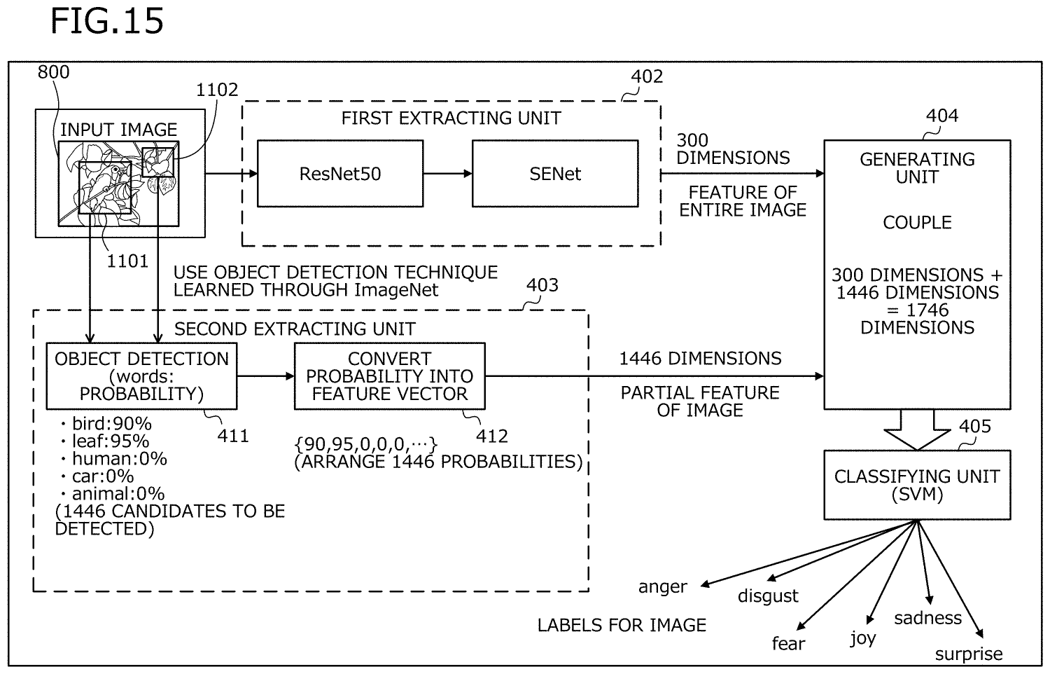

Description proceeds to FIG. 15, and a case is described in which the machine learning device 100 generates the second feature vector by a technique different from the techniques in the descriptions of FIGS. 11 and 14.

(15-1) Similar to (11-1), in FIG. 15, the machine learning device 100 acquires, as an image for learning, the image 800 correlated with the label “joy” indicating an impression.

(15-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(15-3) By the detecting unit 411 included in the second extracting unit 403, the machine learning device 100 detects, from the image 800, each of 1446 objects to be candidates for detection, and outputs the result of detection to the converting unit 412.

For example, the detecting unit 411 detects a bird from the portion 1101 of the image 800 by using the object detection technique learned through ImageNet, and obtains, by calculation, a probability of 90% that the image 800 shows a bird.

Similarly, the detecting unit 411 detects a leaf from the portion 1102 of the image 800, and obtains, by calculation, a probability of 95% that the image 800 shows a leaf. At this time, the detecting unit 411 sets to 0%, the probabilities that the image 800 shows a human, a car, an animal, etc. which have not been detected. Thus, the machine learning device 100 may easily take into consideration the impression of combined objects as well.

(15-4) By the converting unit 412 included in the second extracting unit 403, the machine learning device 100 generates a second feature vector for an object, based on the result of detection.

The converting unit 412 generates, for example, a feature vector of 1446 dimensions in which the probabilities of the image 800 showing a bird, a leaf, a human, a car, an animal, etc. are arranged as elements, and sets the generated feature vector as the second feature vector. Thus, the machine learning device 100 may obtain a second feature vector representative of a partial feature of the image 800.

(15-5) Similar to (11-5), the machine learning device 100 couples the first feature vector and the second feature vector together, by the generating unit 404.

(15-6) Similar to (11-6), by the classifying unit 405, the machine learning device 100 generates training data in which the third feature vector is correlated with a correct label, and updates the model based on the training data. As a result, the machine learning device 100 may update the model so as to be able to estimate the impression of an image with high accuracy.

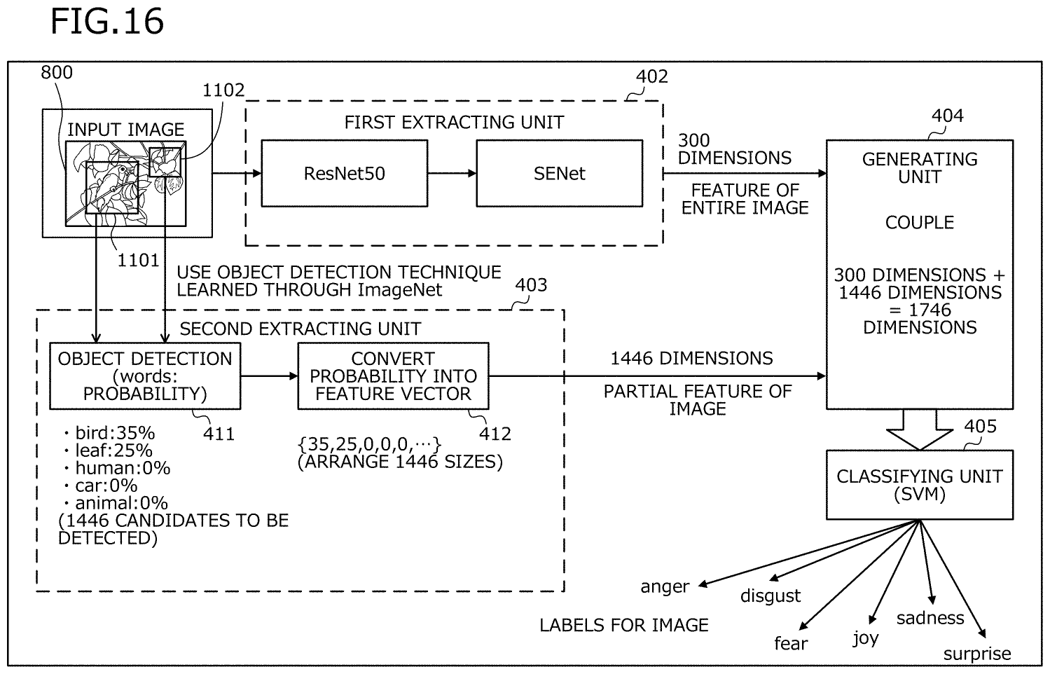

Description proceeds to FIG. 16, and a case is described in which the machine learning device 100 generates the second feature vector by a technique different from the techniques in the descriptions of FIGS. 11 and 15.

(16-1) Similar to (11-1), in FIG. 16, the machine learning device 100 acquires, as an image for learning, the image 800 correlated with the label “joy” indicating an impression.

(16-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(16-3) By the detecting unit 411 included in the second extracting unit 403, the machine learning device 100 detects, from the image 800, each of 1446 objects to be candidates for detection, and outputs the result of detection to the converting unit 412.

For example, the detecting unit 411 detects a bird from the portion 1101 of the image 800 by using the object detection technique learned through ImageNet, and specifies a size of 35% at which the image 800 shows a bird.

Similarly, the detecting unit 411 detects a leaf from the portion 1102 of the image 800, and specifies a size of 25% at which the image 800 shows a leaf. At this time, the detecting unit 411 sets to 0%, the sizes in the image 800, of a human, a car, an animal, etc. which have not been detected. Thus, the machine learning device 100 may easily take into consideration the impression of combined objects as well.

(16-4) By the converting unit 412 included in the second extracting unit 403, the machine learning device 100 generates a second feature vector for an object, based on the result of detection.

The converting unit 412 generates, for example, a feature vector of 1446 dimensions in which the sizes in the image 800, of a bird, a leaf, a human, a car, an animal, etc. are arranged as elements, and sets the generated feature vector as the second feature vector. Thus, the machine learning device 100 may obtain a second feature vector representative of a partial feature of the image 800.

(16-5) Similar to (11-5), the machine learning device 100 couples the first feature vector and the second feature vector together, by the generating unit 404.

(16-6) Similar to (11-6), by the classifying unit 405, the machine learning device 100 generates training data in which the third feature vector is correlated with a correct label, and updates the model based on the training data. As a result, the machine learning device 100 may update the model so as to be able to estimate the impression of an image with high accuracy.

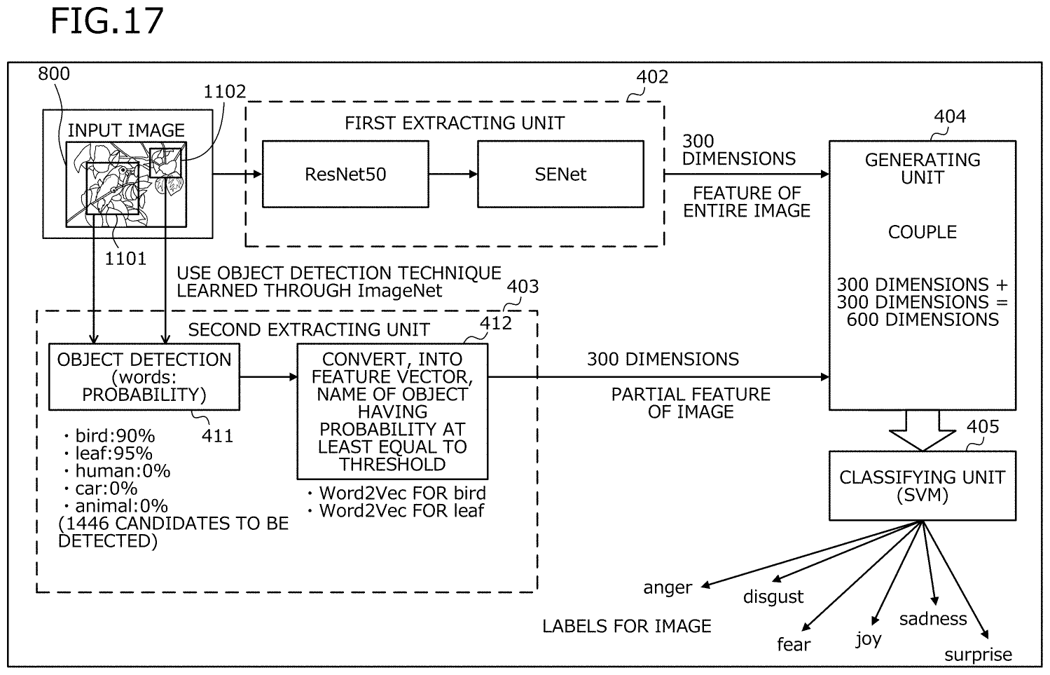

Description proceeds to FIG. 17, and a case is described in which the machine learning device 100 generates the second feature vector by a technique different from the techniques in the descriptions of FIGS. 11 and 16.

(17-1) Similar to (11-1), in FIG. 17, the machine learning device 100 acquires, as an image for learning, the image 800 correlated with the label “joy” indicating an impression.

(17-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(17-3) By the detecting unit 411 included in the second extracting unit 403, the machine learning device 100 detects, from the image 800, each of 1446 objects to be candidates for detection, and outputs the result of detection to the converting unit 412.

For example, the detecting unit 411 detects a bird from the portion 1101 of the image 800 using the object detection technique learned through ImageNet, and obtains, by calculation, a probability of 90% that the image 800 shows a bird.

Similarly, the detecting unit 411 detects a leaf from the portion 1102 of the image 800, and obtains, by calculation, a probability of 95% that the image 800 shows a leaf. At this time, the detecting unit 411 sets to 0%, the probabilities that the image 800 shows a human, a car, an animal, etc. which have not been detected. Thus, the machine learning device 100 may easily take into consideration the impression of combined objects as well.

(17-4) By the converting unit 412 included in the second extracting unit 403, the machine learning device 100 generates a second feature vector for an object, based on the result of detection.

For example, the converting unit 412 specifies a bird and a leaf whose respective probabilities of appearing in the image 800 are at least equal to a threshold value. The converting unit 412 converts the specified bird and leaf into feature vectors of 300 dimensions with word2vec. The converting unit 412 sets the sum of the converted feature vectors as the second feature vector.

For example, there may be a case in which the converting unit 412 converts a leaf having a maximum probability of appearing in the image 800 into a feature vector of 300 dimensions with word2vec and sets the generated feature vector as the second feature vector. Thus, the machine learning device 100 may obtain a second feature vector representative of a partial feature of the image 800.

(17-5) Similar to (11-5), the machine learning device 100 couples the first feature vector and the second feature vector together, by the generating unit 404.

(17-6) Similar to (11-6), by the classifying unit 405, the machine learning device 100 generates training data in which the third feature vector is correlated with a correct label, and updates the model based on the training data. As a result, the machine learning device 100 may update the model so as to be able to estimate the impression of an image with high accuracy.

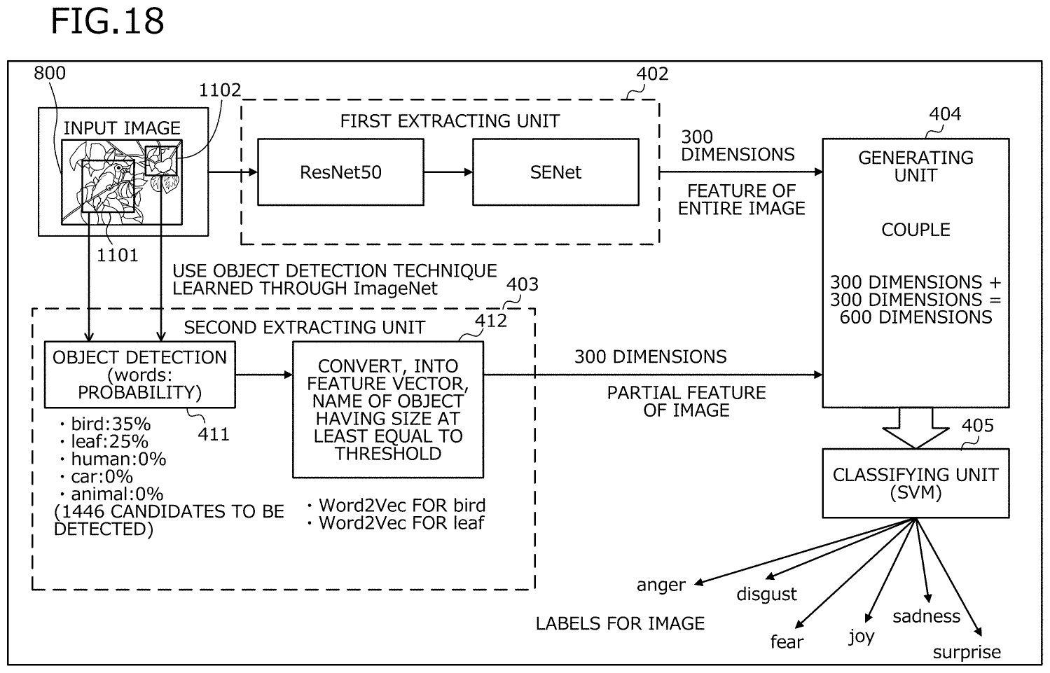

Description proceeds to FIG. 18, and a case is described in which the machine learning device 100 generates the second feature vector by a technique different from the techniques in the descriptions of FIGS. 11 and 17.

(18-1) Similar to (11-1), in FIG. 18, the machine learning device 100 acquires, as an image for learning, the image 800 correlated with the label “joy” indicating an impression.

(18-2) Similar to (11-2), the machine learning device 100, by the first extracting unit 402, generates, from the image 800, a first feature vector for the entire image 800. Thus, the machine learning device 100 may obtain the first feature vector representative of a feature of the entire image 800.

(18-3) By the detecting unit 411 included in the second extracting unit 403, the machine learning device 100 detects, from the image 800, each of 1446 objects to be candidates for detection, and outputs the result of detection to the converting unit 412.

For example, the detecting unit 411 detects a bird from the portion 1101 of the image 800 by using the object detection technique learned through ImageNet, and specifies a size of 35% at which the image 800 shows a bird.

Similarly, the detecting unit 411 detects a leaf from the portion 1102 of the image 800, and specifies a size of 25% at which the image 800 shows a leaf. At this time, the detecting unit 411 sets to 0%, the sizes in the image 800, of a human, a car, an animal, etc. which have not been detected. Thus, the machine learning device 100 may easily take into consideration the impression of combined objects as well.

(18-4) By the converting unit 412 included in the second extracting unit 403, the machine learning device 100 generates a second feature vector for an object based on the result of detection.

For example, the converting unit 412 specifies a bird and a leaf whose respective sizes in the image 800 are at least equal to a threshold value. The converting unit 412 converts the specified bird and leaf into feature vectors of 300 dimensions with word2vec. The converting unit 412 sets the sum of the converted feature vectors as the second feature vector.

For example, there may be a case where the converting unit 412 converts a bird having a maximum size in the image 800 into a feature vector of 300 dimensions with word2vec and sets the resulting feature vector as the second feature vector. Thus, the machine learning device 100 may obtain a second feature vector representative of a partial feature of the image 800.

(18-5) Similar to (11-5), the machine learning device 100 couples the first feature vector and the second feature vector together, by the generating unit 404.

(18-6) Similar to (11-6), by the classifying unit 405, the machine learning device 100 generates training data in which the third feature vector is correlated with a correct label, and updates the model based on the training data. As a result, the machine learning device 100 may update the model so as to be able to estimate the impression of an image with high accuracy.

Although here, with reference to FIGS. 11 to 18, the plural techniques have been described by which the converting unit 412 calculates the second feature vector, this is not limitative. For example, the converting unit 412 may calculate the second feature vector, based on a combination of any two or more among: the probability of each object appearing on an image, the size of each object in the image, and a color feature of a portion of each object appearing in the image.

For example, the converting unit 412 may calculate the second feature vector, based on the position of each object in an image. In this case, for example, it is conceivable that for each object in the image, the closer the object is positioned to the center, the converting unit 412 imparts a greater weight to the probability that the object appears in the image, arranges the probabilities as elements to, thereby, calculate the second feature vector.

The converting unit 412 may set, as the second feature vector, for example, a feature vector of 1446 dimensions in which peak luminances of a bird, a leaf, a human, a car, an animal, etc. are arranged as they are, as elements.

With reference to FIG. 19, an example is described in which the machine learning device 100 estimates the impression of a subject image using the model learned in FIG. 11.

FIG. 19 is an explanatory view of an example of estimating the impression of a subject image. (19-1) In FIG. 19, the machine learning device 100 acquires the image 800 as a subject image. The machine learning device 100 receives the image 800 from the client device 201.

(19-2) The machine learning device 100, by the first extracting unit 402, generates, from the image 800, a fourth feature vector for the entire image 800. The first extracting unit 402 generates the fourth feature vector for the entire image 800 by, for example, ResNet50 with built-in SENet. The fourth feature vector has, for example, 300 dimensions. Thus, the machine learning device 100 may obtain the fourth feature vector representative of a feature of the entire image 800.

(19-3) By the detecting unit 411 included in the second extracting unit 403, the machine learning device 100 detects, from the image 800, each of 1446 objects to be candidates for detection and outputs the result of detection to the converting unit 412. The objects to be candidates for detection are, for example, a bird, a leaf, a human, a car, an animal, etc.

For example, using the object detection technique learned through ImageNet, the detecting unit 411 detects a bird from the portion 1101 of the image 800 and obtains, by calculation, a probability of 90% that the image 800 shows a bird. In the same manner, the detecting unit 411 detects a leaf from the portion 1102 of the image 800 and obtains, by calculation, a probability of 95% that the image 800 shows a leaf. At this time, the detecting unit 411 sets to 0%, the probabilities that the image 800 shows a human, a car, an animal, etc. which have not been detected.

(19-4) By the converting unit 412 included in the second extracting unit 403, the machine learning device 100 generates a fifth feature vector for an object, based on the result of detection.

The converting unit 412 generates, for example, a feature vector of 1446 dimensions in which the probabilities that the image 800 shows a bird, a leaf, a human, a car, an animal, etc. are arranged as elements. Using principal component analysis (PCA), the converting unit 412 then converts the generated feature vector of 1446 dimensions into a feature vector of 300 dimensions, performs normalization, and sets the normalized feature vector as the fifth feature vector. In the PCA, 300 dimensions having a relatively large dispersion are set as dimensions of the conversion destination. Thus, the machine learning device 100 may obtain a fifth feature vector representative of a partial feature of the image 800.

(19-5) The machine learning device 100 couples the fourth feature vector and the fifth feature vector together, by the generating unit 404. The generating unit 404 couples, for example, the fourth feature vector of 300 dimensions and the fifth feature vector of 300 dimensions together and thereby, generates a sixth feature vector of 600 dimensions.

(19-6) The machine learning device 100, by the classifying unit 405, specifies, using a model, a label indicating an impression of a subject image that corresponds to the sixth feature vector. The model is, for example, SVM. For example, the classifying unit 405 inputs the sixth feature vector into the model and thereby, acquires a label “joy” indicating an impression output by the model, and specifies the label “joy” as the label indicating an impression of the subject image. As a result, the machine learning device 100 may estimate the impression of an image with high accuracy.

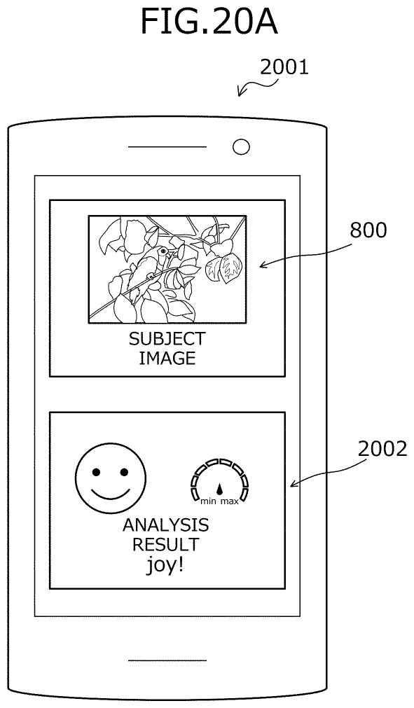

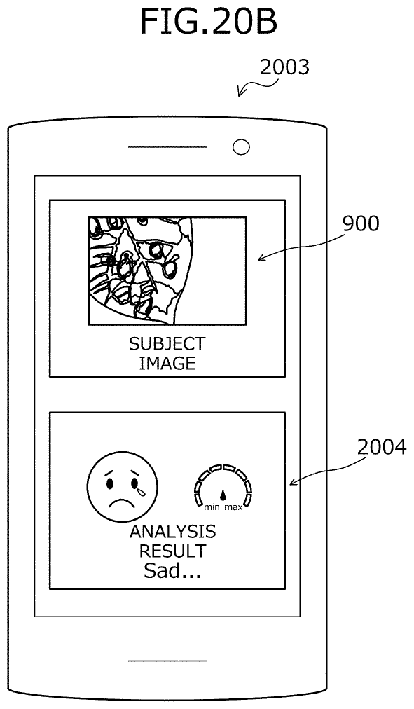

The machine learning device 100 causes a display of the client device 201 to display the specified label indicating an impression of the subject image. Next, with reference to FIGS. 20A and 20B, an example is described in which the machine learning device 100 causes a display of the client device 201 to display a specified label indicating an impression of a subject image.

FIGS. 20A and 20B are explanatory views of display examples of a label indicating an impression of a subject image. In FIG. 20A, in a case, for example, of acquiring the image 800 as a subject image from the client device 201, the machine learning device 100 transmits the specified label “joy” indicating an impression to the client device 201, which is caused to display a screen 2001. The screen 2001 includes the image 800 as a subject image, and a display field 2002 to give notification of the specified label “joy” indicating an impression. As a result, the machine learning device 100 enables the user of the client device 201 to know the specified label “joy” indicating an impression.

In a case, for example, of acquiring the image 900 as a subject image from the client device 201, the machine learning device 100 transmits the specified label “sadness” indicating an impression to the client device 201, which is caused to display a screen 2003 depicted in FIG. 20B. The screen 2001 includes the image 900 as a subject image, and a display field 2004 to give notification of the specified label “sadness” indicating an impression. As a result, the machine learning device 100 enables the user of the client device 201 to know the specified label “sadness” indicating an impression.

Although here a case has been described in which the machine learning device 100 estimates the impression of an image using the model learned in FIG. 11, this is not limitative. For example, the machine learning device 100 may use any one of the models learned in FIGS. 12 to 18.

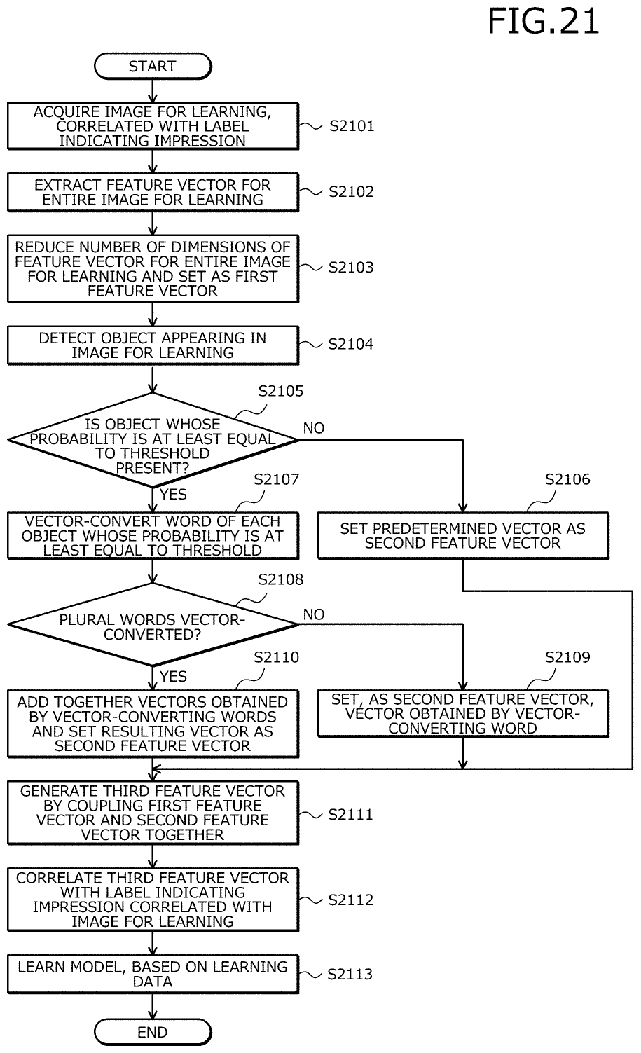

Next, with reference to FIG. 21, an example of a learning procedure executed by the machine learning device 100 is described. The learning process is implemented by, for example, the CPU 301 depicted in FIG. 3, the storage area such as the memory 302 and the storage medium 305, and the network I/F 303.

FIG. 21 is a flowchart of an example of the learning procedure. In FIG. 21, the machine learning device 100 acquires an image that is for learning and correlated with a label indicating an impression (step S2101).

Next, the machine learning device 100 extracts from the acquired image for learning, a feature vector for the entire image for learning (step S2102). The machine learning device 100 then reduces the number of dimensions of the feature vector for the entire image for learning and sets the feature vector of reduced dimensions as a first feature vector (step S2103).

Next, among plural objects set as candidates to be detected, the machine learning device 100 detects an object appearing in the acquired image for learning (step S2104). The machine learning device 100 then determines whether of the objects set as candidates to be detected, there is an object whose probability of appearing in the image for learning is at least equal to a threshold value (step S2105).

When there is no object whose probability of appearing in the image for learning is at least equal to a threshold value (step S2105: NO), the machine learning device 100 sets a predetermined vector as a second feature vector (step S2106). The machine learning device 100 then goes to processing at step S2111. On the other hand, when there is an object whose probability of appearing in the image for learning is at least equal to the threshold value (step S2105: YES), the machine learning device 100 goes to processing at step S2107.

At step S2107, the machine learning device 100 vector-converts into a vector, a word of each object whose probability of appearing in the image for learning is at least equal to a threshold value (step S2107). The machine learning device 100 then determines whether plural words have been vector-converted (step S2108).

When plural words have not been vector-converted (step S2108: NO), the machine learning device 100 sets the vector obtained by vector-converting the word as a second feature vector (step S2109). The machine learning device 100 then goes to processing at step S2111.

On the other hand, when plural words have been vector-converted (step S2108: YES), the machine learning device 100 adds together the vectors obtained by vector-converting the words and sets the resulting vector after addition as the second feature vector (step S2110). The machine learning device 100 then goes to processing at step S2111.

At step S2111, the machine learning device 100 couples the first feature vector and the second feature vector together and thereby, generates a third feature vector (step S2111). The machine learning device 100 then correlates the third feature vector with a label indicating an impression correlated with the acquired image for learning and thereby, generates training data (step S2112).

Next, the machine learning device 100 learns a model, based on the generated training data (step S2113). The machine learning device 100 then terminates the learning process. Thus, the machine learning device 100 may learn a model capable of accurately estimating the impression of an image.

Although here a case is described in which the machine learning device 100 learns a model using the third vector generated based on a single image for learning, this is not limitative. For example, when there are plural images for learning, the machine learning device 100 may repeatedly execute the learning process based on each image for learning to update the model.

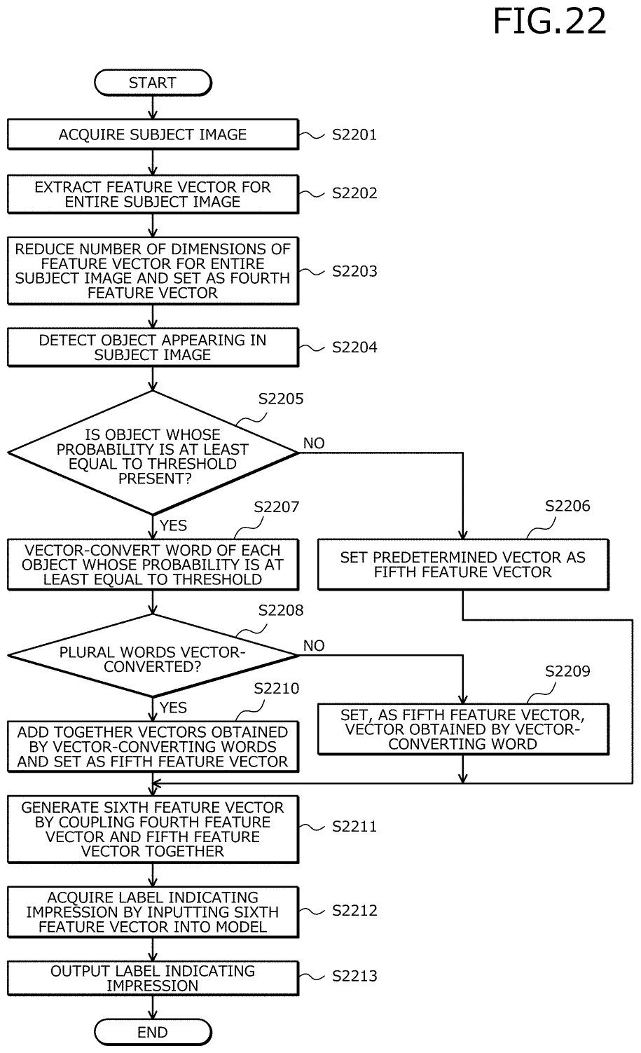

Next, with reference to FIG. 22, an example of an estimating procedure executed by the machine learning device 100 is described. The estimating process is implemented by, for example, the CPU 301 depicted in FIG. 3, the storage area such as the memory 302 and the storage medium 305, and the network I/F 303.

FIG. 22 is a flowchart of an example of the estimating procedure. In FIG. 22, the machine learning device 100 acquires a subject image (step S2201).

Next, the machine learning device 100 extracts from the acquired subject image, a feature vector for the entire subject image (step S2202). The machine learning device 100 then reduces the number of dimensions of the feature vector for the entire subject image and sets the feature vector of reduced dimensions as a fourth feature vector (step S2203).

Next, among plural objects set as candidates to be detected, the machine learning device 100 detects an object appearing in the acquired subject image (step S2204). The machine learning device 100 then determines whether among the objects set as candidates to be detected, there is an object whose probability of appearing in the learning image is at least equal to a threshold value (step S2205).

When there is no object whose probability of appearing in the learning image is at least equal to the threshold value (step S2205: NO), the machine learning device 100 sets a predetermined vector as a fifth feature vector (step S2206). The machine learning device 100 then goes to processing at step S2211. On the other hand, when there is an object whose probability of appearing in the learning image is at least equal to the threshold value (step S2205: YES), the machine learning device 100 goes to processing at step S2207.

At step S2207, the machine learning device 100 vector-converts a word of each object whose probability of appearing in the learning image is at least equal to a threshold value (step S2207). The machine learning device 100 then determines whether plural words have been vector-converted (step S2208).

When plural words have not been vector-converted (step S2208: NO), the machine learning device 100 sets the vector obtained by vector-converting the word, as the fifth feature vector (step S2209). The machine learning device 100 then goes to processing at step S2211.

On the other hand, when plural words have been vector-converted (step S2208: YES), the machine learning device 100 adds together the vectors obtained by vector-converting the words and sets the resulting vector after addition as the fifth feature vector (step S2210). The machine learning device 100 then goes to processing at step S2211.

At step S2211, the machine learning device 100 couples the fourth feature vector and the fifth feature vector together and thereby, generates a sixth feature vector (step S2211). The machine learning device 100 then inputs the sixth feature vector into the model and thereby, acquires a label indicating an impression (step S2212).

Next, the machine learning device 100 outputs the acquired label indicating an impression (step S2213). The machine learning device 100 then terminates the estimating process. Thus, the machine learning device 100 may estimate the impression of an image with high accuracy and render the image impression estimation result available.

Here, the machine learning device 100 may change the order of processes at some steps in the flowcharts of FIGS. 21 and 22 to execute the processes. For example, the order of the processes at steps S2102 and S2103 and the processes at steps S2104 to S2110 may be interchanged. Similarly, for example, the order of the processes at steps S2202 and S2203 and the processes at steps S2204 to S2210 may be interchanged.

As set forth hereinabove, the machine learning device 100 may acquire an image. The machine learning device 100 may extract, from the acquired image, a first feature vector for the entire image. The machine learning device 100 may extract, from the acquired image, a second feature vector for an object. The machine learning device 100 may combine the extracted first feature vector and the extracted second feature vector together and thereby, generate a third feature vector. The machine learning device 100 may learn a model that outputs a label indicating an impression corresponding to the input feature vector, based on training data in which the generated third feature vector is correlated with a label indicating an impression of an image. Thus, the machine learning device 100 may learn a model capable of accurately estimating the impression of an image.

The machine learning device 100 may calculate a probability that each of one or more objects appears on an image, based on the result of analysis of the image. The machine learning device 100 may extract a second feature vector, based on the calculated probability. Thus, the machine learning device 100 may obtain the second feature vector representative of a partial feature of an image.

The machine learning device 100 may determine whether each of one or more objects appears on an image, based on the result of analysis of the image. The machine learning device 100 may extract a second feature vector, based on the name of an object determined as appearing on an image, of one or more objects. Thus, the machine learning device 100 may obtain the second feature vector representative of a partial feature of an image.

The machine learning device 100 may specify the size of each of one or more objects in an image, based on the result of analysis of the image. The machine learning device 100 may extract the second feature vector, based on the specified size. Thus, the machine learning device 100 may obtain the second feature vector representative of a partial feature of an image.

The machine learning device 100 may determine whether each of one or more objects appears in an image, based on the result of analysis of the image. The machine learning device 100 may specify the size in the image, of an object that among one or more objects is determined as appearing in the image. The machine learning device 100 may extract a second feature vector, based on the specified size. Thus, the machine learning device 100 may obtain the second feature vector representative of a partial feature of an image.

The machine learning device 100 may specify a color feature on an image of each of one or more objects, based on the result of analysis of the image. The machine learning device 100 may extract a second feature vector, based on the specified color feature. Thus, the machine learning device 100 may obtain the second feature vector representative of a partial feature of an image.

The machine learning device 100 may determine whether each of one or more objects appears in an image, based on the result of analysis of the image. The machine learning device 100 may specify a color feature in an image, of an object that among one or more objects is determined as appearing in the image. The machine learning device 100 may extract a second feature vector, based on the specified color feature. Thus, the machine learning device 100 may obtain the second feature vector representative of a partial feature of an image.

The machine learning device 100 may couple a second feature vector of M dimensions to a first feature vector of N dimensions and thereby, generate a third feature vector of N+M dimensions. Thus, the machine learning device 100 may generate the third feature vector so as to represent an entire feature of an image and a partial feature of the image.

The machine learning device 100 may acquire a subject image. The machine learning device 100 may extract, from the acquired subject image, a fourth feature vector for the entire subject image. The machine learning device 100 may extract, from the acquired subject image, a fifth feature vector for an object. The machine learning device 100 may combine the extracted fourth feature vector and the extracted fifth feature vector together and thereby, generate a sixth feature vector. Using the learned model, the machine learning device 100 may output a label indicating an impression corresponding to the generated sixth feature vector. Thus, the machine learning device 100 may estimate the impression of a subject image with high accuracy.

According to the machine learning device 100, the support vector machine may be used as a model. As a result, the machine learning device 100 may accurately estimate the impression of an image by using the model.

The machine learning method described in the present embodiment may be implemented by executing a prepared program on a computer such as a personal computer and a workstation. The program is stored on a non-transitory, computer-readable recording medium such as a hard disk, a flexible disk, a compact disk (CD)-ROM, an MO, and a digital versatile disk (DVD), read out from the computer-readable medium, and executed by the computer. The program may be distributed through a network such as the Internet.

According to one aspect, it becomes possible to learn a model capable of estimating the impression of an image with high accuracy.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented machine learning method comprising:
acquiring an image;
generating a first feature vector based on entirety of the image;
generating a second feature vector based on a result of object detection for the image;
generating a third feature vector by combining the first feature vector and the second feature vector; and
training a machine learning model in accordance with training data in which the third feature vector is associated with a label indicating an impression of the image.

2. The machine learning method according to claim 1, wherein the result of object detection for the image includes a probability that each of one or more objects are included in the image.

3. The machine learning method according to claim 1, wherein the result of object detection for the image includes a name of an object detected in the image.

4. The machine learning method according to claim 1, wherein the result of object detection for the image includes a size of an object detected in the image.

5. The machine learning method according to claim 1, wherein the result of object detection for the image includes a color feature of an object detected in the image.

6. The machine learning method according to claim 1, wherein the generating of the third feature vector includes generating the third feature vector of N+M dimensions by coupling the second feature vector of M dimensions to the first feature vector of N dimensions.

7. The machine learning method according to claim 1, further comprising:
acquiring another image;
generating a fourth feature vector based on entirety of the another image;
generating a fifth feature vector based on a result of object detection for the another image;
generating a sixth feature vector by combining the fourth feature vector and the fifth feature vector; and
outputting a label indicating an impression corresponding to the generated sixth feature vector, by using the trained machine learning model.

8. The machine learning method according to claim 1, wherein the machine learning model is a support vector machine.

9. A computer-readable recording medium storing therein a machine learning program executable by one or more computers, the machine learning program comprising:
an instruction for acquiring an image;
an instruction for generating a first feature vector based on entirety of the image;
an instruction for generating a second feature vector based on a result of object detection for the image;
an instruction for generating a third feature vector by combining the first feature vector and the second feature vector; and
an instruction for training a machine learning model in accordance with training data in which the third feature vector is associated with a label indicating an impression of the image.

10. The computer-readable recording medium according to claim 9, wherein the result of object detection for the image includes a probability that each of one or more objects are included in the image.

11. The computer-readable recording medium according to claim 9, wherein the result of object detection for the image includes a name of an object detected in the image.

12. The computer-readable recording medium according to claim 9, wherein the result of object detection for the image includes a size of an object detected in the image.

13. The computer-readable recording medium according to claim 9, wherein the result of object detection for the image includes a color feature of an object detected in the image.

14. The computer-readable recording medium according to claim 9, wherein the generating of the third feature vector includes generating the third feature vector of N+M dimensions by coupling the second feature vector of M dimensions to the first feature vector of N dimensions.

15. The computer-readable recording medium according to claim 9, further comprising:
acquiring another image;
generating a fourth feature vector based on entirety of the another image;
generating a fifth feature vector based on a result of object detection for the another image;
generating a sixth feature vector by combining the fourth feature vector and the fifth feature vector; and
outputting a label indicating an impression corresponding to the generated sixth feature vector, by using the trained machine learning model.

16. The computer-readable recording medium according to claim 9, wherein the machine learning model is a support vector machine.

17. A machine learning device comprising:
a memory; and
a processor coupled to the memory, the processor being configured to:
acquire an image,
generate a first feature vector based on entirety of the image,
generate a second feature vector based on a result of object detection for the image,
generate a third feature vector by combining the first feature vector and the second feature vector, and
training a machine learning model in accordance with training data in which the third feature vector is associated with a label indicating an impression of the image.
